(19) United States
(12) Patent Application Publication
(10) Pub. No.: US 2022/0374702 A1
(43) Pub. Date: Nov. 24, 2022

(54) METHODS AND SYSTEMS FOR PREDICTING BEHAVIOR OF DISTRIBUTED APPLICATIONS

(71) Applicant: VMware, Inc., Palo Alto, CA (US)

(72) Inventors: Nicholas Kushmerick, Seattle, WA (US); Ilia Pantechev, Sofia (BG); Nikhil Khani, Palo Alto, CA (US)

(73) Assignee: VMware, Inc., Palo Alto, CA (US)

(21) Appl. No.: 17/308,349

(22) Filed: May 5, 2021

(51) Int. Cl. G06N 3/08; G06N 3/04

(52) U.S. Cl. CPC G06N 3/08; G06N 3/0454

(57) ABSTRACT

Computational methods and systems described herein are directed to predicting behavior of a distributed application in response to proposed changes to the distributed application and/or proposed changes to a distributed computing system in which the distributed application is running. A training set of graphs of a distributed computing environment of the distributed application is constructed. Each graph represents a state of the distributed computing environment at a point in time. Machine learning techniques train a neural network (“NN”) model that outputs key performance indicators (“KPIs”) of the distributed application in response to changes to the distributed computing environment. When a user proposes a change, the NN model predicts KPIs that indicate how the distributed application is impacted by the proposed change. Predicted KPIs are compared with KPIs that represent current performance of the distributed application to determine whether the proposed change is expected to improve performance of the distributed application.

### TECHNICAL FIELD

The present disclosure is directed to computer-implemented methods and systems for predicting the behavior of a distributed application in response to proposed changes to the distributed application and/or distributed computing system used to execute the distributed application.

### BACKGROUND

Electronic computing has evolved from primitive, vacuum-tube-based computer systems, initially developed during the 1940s, to modern electronic computing systems in which large numbers of multi-processor computer systems, such as server computers, workstations, and other individual computing systems are networked together with large-capacity data-storage devices and other electronic devices to produce distributed computing systems that communicate with each other, provide enormous computational bandwidths and data-storage capacities. These large, distributed computing systems are typically housed in data centers and made possible by advances in computer networking, distributed operating systems and applications, data-storage appliances, computer hardware, and advances in software technologies.

Enterprises, governments, and other organizations now conduct commerce, provide services over the Internet, and process large volumes of data using distributed applications executed in distributed computing systems. A distributed application comprises multiple software components that are executed on one or more server computers. The software components communicate and coordinate actions to appear as a single coherent application to an end user. Consider, for example, a distributed application that provides banking services to users via a bank website or a mobile application (“mobile app”) executed on a mobile device. One component provides front-end services that enable users to input banking requests and receive responses to requests via the website or the mobile app. Each user only sees the features provided by the website or mobile app. Other components of the distributed application provide back-end services that are executed in the distributed computing system. These services include processing user banking requests, maintaining data storage, and retrieving user information from data storage.

Virtualization has made a major contribution to executing distributed applications in a distributed computing system. Virtualization provides for the creation of software-based, or virtual, representations of server computers, data-storage devices, and networks. For example, a virtual computer system, known as a virtual machine (“VM”), is a self-contained application and operating system implemented in software. Software components of a distributed application may be executed separately in VMs. A VM may be created or destroyed on demand and may be migrated from one physical server computer to another in a data center. Virtualization has enabled scaling of distributed applications and distributed computing systems to meet changing user demand.

In recent years, management tools have been developed to manage distributed applications executing in a distributed computing system. Managing a distributed application executed on a cluster of server computers, for example, involves adding server computers, migrating VMs to different server computers within the cluster, scaling up and down VMs, disconnecting server computers, changing server computer parameters, such as adding memory and upgrading server computer software. These changes are made to resolve cluster issues, such as poor performance, satisfy security policies, plan for future computational demands (e.g., a seasonal increase in sales), and reclaim wasted resources. However, many of these changes may have unintended consequences. For example, creating additional VMs of a distributed application to handle an increase in demand for services may have the unintended consequence of creating contention for CPUs and memory of a cluster, increasing network traffic beyond capacity of the cluster network, or exceeding data storage limits, all of which slow performance of the distributed application executing on the cluster. As another example, adding a server computer to a cluster already executing a distributed application may increase input output operations per unit time for certain VMs, but such an addition may increase cluster network traffic beyond the network's capacity, creating congestion that ultimately slows performance of the distributed application.

Changes to a distributed computing system used to run a distributed application can lead to outages and slowdowns. Organizations cannot afford downtime or slow performance of their applications because performance issues frustrate users, damage a brand name, result in lost revenue, and deny people access to vital services. The problems described above typically arise because existing management tools are not able to predict the impact such changes may have on execution of a distributed application. As a result, administrators and application owners are slow to execute important changes to a distributing computing environment out of fear that a change may negatively impact performance of their distributed applications. Administrators and distributed application owners seek management tools that can predict the behavior of a distributed application in response to proposed changes to the distributed application and/or the distributed computing system used to execute the distributed application.

### SUMMARY

Methods and systems described herein are directed to predicting behavior of a distributed application in response to proposed changes to the distributed application and/or proposed changes to a distributed computing system in which the distributed application is running. Methods and systems construct a training set of graphs of a distributed computing environment of the distributed application. The distributed computing environment comprises the distributed application and hardware of the distributed computing system used by the distributed application. Each graph represents a state of the distributed computing environment at a point in time. Nodes of a graph represent objects of the distributed computing environment, edges represent causal relationships between the objects, node labels represent operational data about the objects (e.g., metrics and properties), and node outputs represent key performance indicators (“KPIs”) of the distributed application. Methods and systems use machine learning techniques to train a neural network (“NN”) model based on the graphs collected over time. The NN model outputs predicted KPIs of the distributed application in response to changes to the distributed computing environment. Methods and systems enable a user to input a “What-if” scenario that corresponds to a proposed change to the distributed computing environment and utilize the NN model to output predicted KPIs that indicate how the distributed application is expected to respond to the proposed change. Predicted KPIs are compared with KPIs that represent current performance of the distributed application to determine whether the proposed change is expected to improve performance of the distributed application. If the proposed change would improve performance of the distributed application, the proposed change may be executed on the distributed computing environment.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-58 show two types of virtual machine (“VW”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows examples of distributed applications in a virtualization layer of a physical data center.

FIG. 14 shows a plot of an example metric.

FIG. 15 shows a table of data collected for an example distributed application.

FIG. 16A shows an example graph.

FIG. 16B shows an example node label matrix, adjacency matrix, and output for the graph shown in FIG. 16A.

FIGS. 17A-17E show an example graph, symmetric matrix, node label matrix, and outputs constructed from table of data shown in FIG. 15.

FIG. 18 shows an example of three consecutive graphs of a training set for the example distributed computing environment shown in FIG. 17E.

FIG. 19 shows state functions and outputs for the nodes of the graph shown in FIG. 16A.

FIG. 20 is a flow diagram of a process of training weights for a graph convolutional (“GCN”) model.

FIGS. 21A-21C show a process of determining a predicted output in a three-layer GCN model.

FIG. 22 shows a representation of computing a predicted output.

FIGS. 23A-23B show an example category (1) What-if scenario applied to a current graph.

FIG. 24 shows an example of creating a set of next graphs from a current graph and a proposed change to a distributed computing environment.

FIGS. 25A-25D show example category (2) What-if scenario applied to a current graph and a proposed change to a distributed computing environment.

FIGS. 26A-26E shows example category (2) What-if scenarios applied to a current graph and proposed changes to a distributed computing environment.

FIG. 27A shows an example of computing a predicted output for each of the next graphs in FIG. 24.

FIG. 278 shows an example of set of predicted outputs.

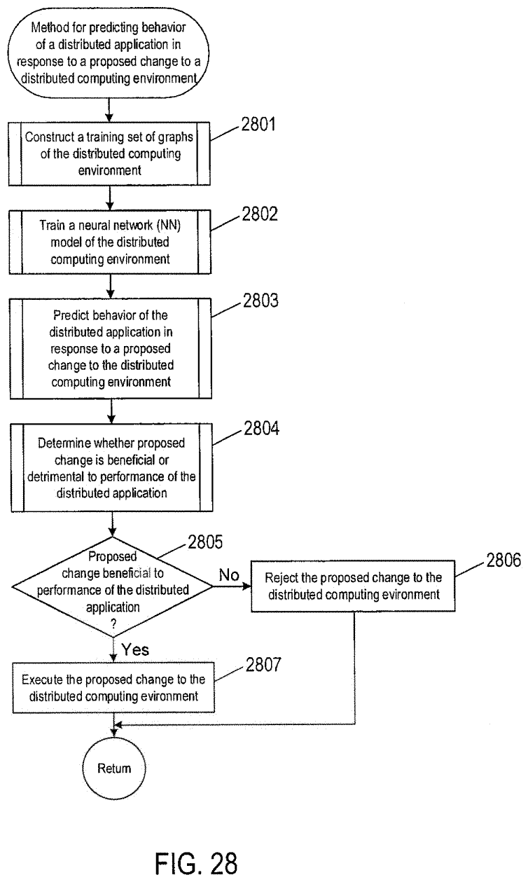

FIG. 28 is a flow diagram of a method for predicting behavior of a distributed application in response to a proposed change to a distributed computing environment.

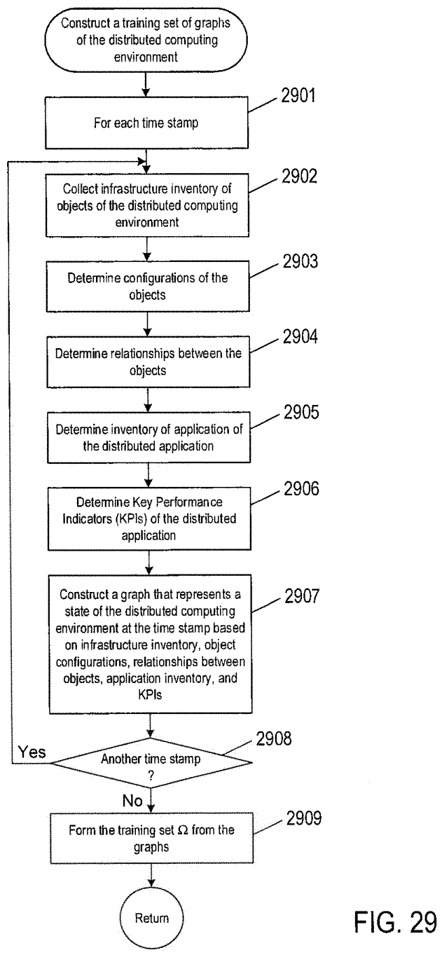

FIG. 29 is a flow diagram illustrating an example implementation of the “construct a training set of graphs of the distributed computing environment” procedure performed in FIG. 28.

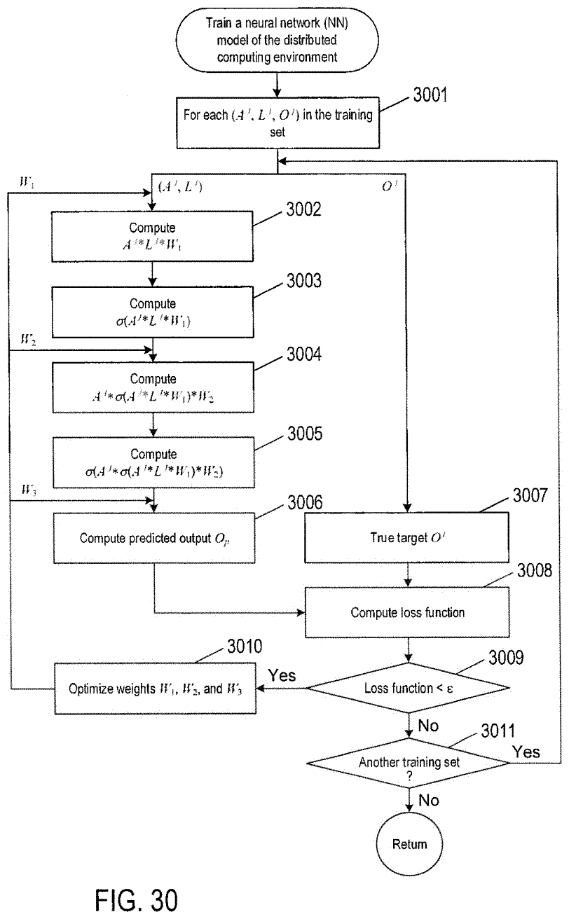

FIG. 30 is a flow diagram illustrating an example implementation of the “train a neural network (“NN”) model of the distributed computing environment” procedure performed in FIG. 28.

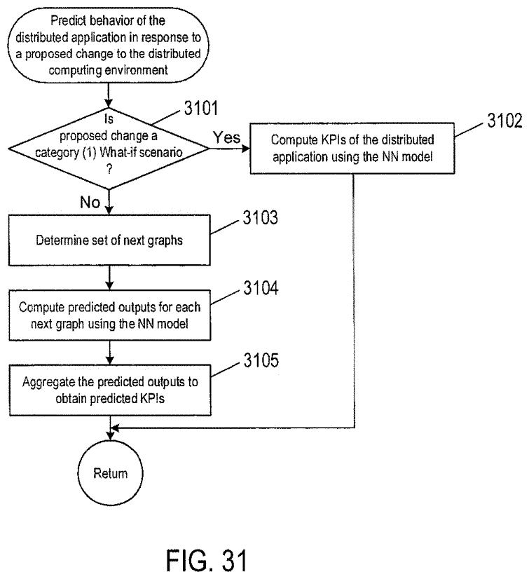

FIG. 31 is a flow diagram illustrating an example implementation of the “predict behavior of the distributed application in response to a proposed change to the distributed computing environment” procedure performed in FIG. 28.

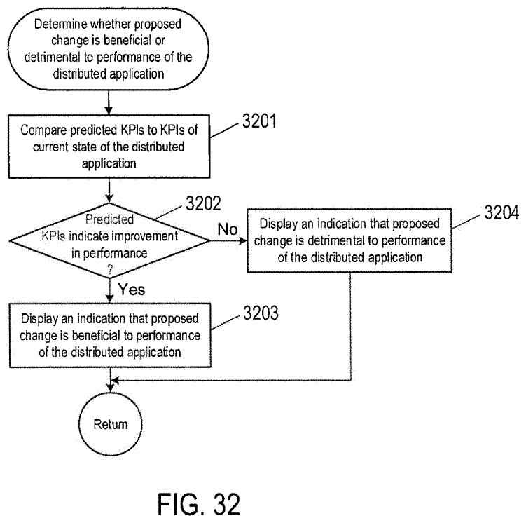

FIG. 32 is a flow diagram illustrating an example implementation of the “determine whether proposed change is beneficial or detrimental to performance of the distributed application” procedure performed in FIG. 28.

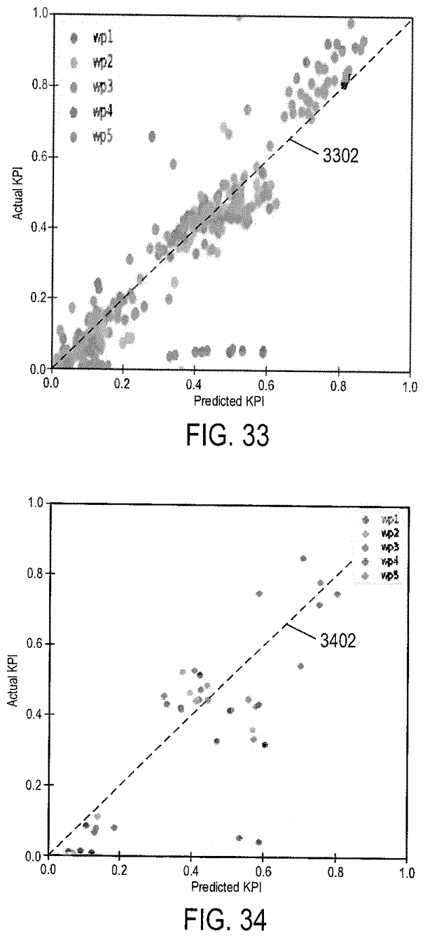

FIG. 33 shows a plot of predicted and actual key performance indicators (“KPIs”) for five applications.

FIG. 34 shows a plot of sample results for predicting KPIs of the applications after a change was made to the cluster of hosts.

### DETAILED DESCRIPTION

This disclosure presents automated methods and systems for predicting behavior of a distributed application in response to proposed changes to the distributed application and/or proposed changes to a distributed computing system that runs the distributed application. In a first subsection, computer hardware, complex computational systems, and virtualization are described. Methods and systems for predicting behavior of a distributed application are described in a second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

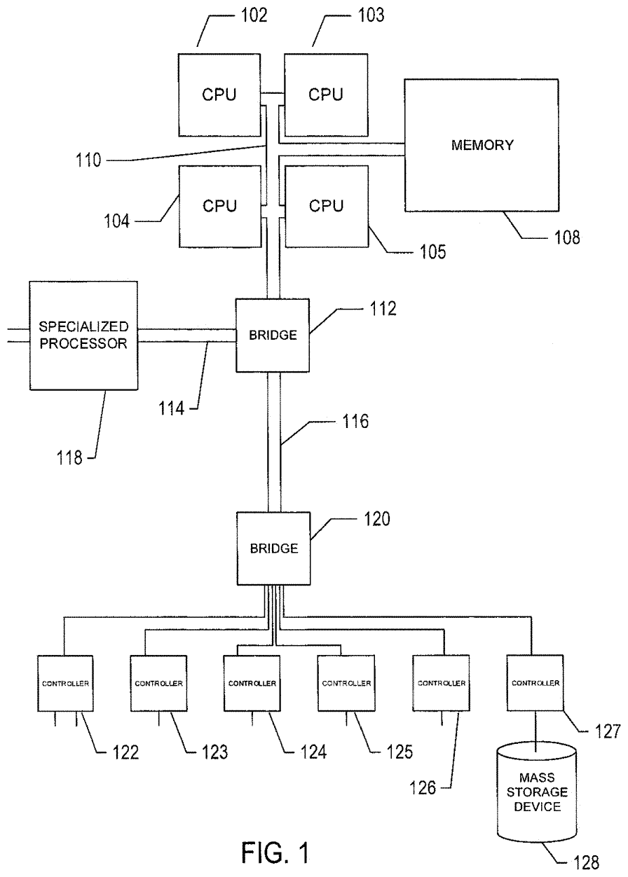

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU-memory-subsystem bus 110 or multiple busses, a first bridge 112 that interconnects the CPU, memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

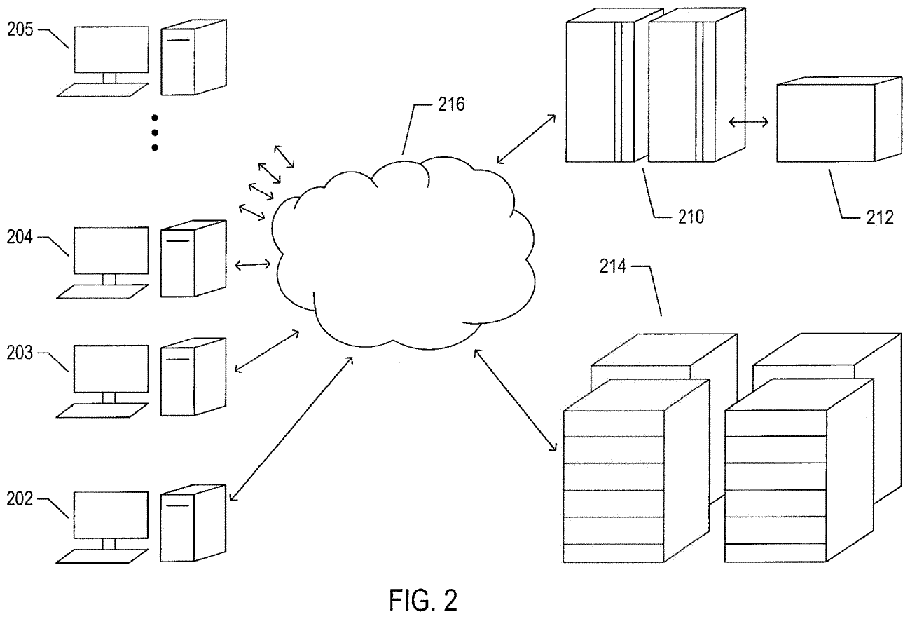

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

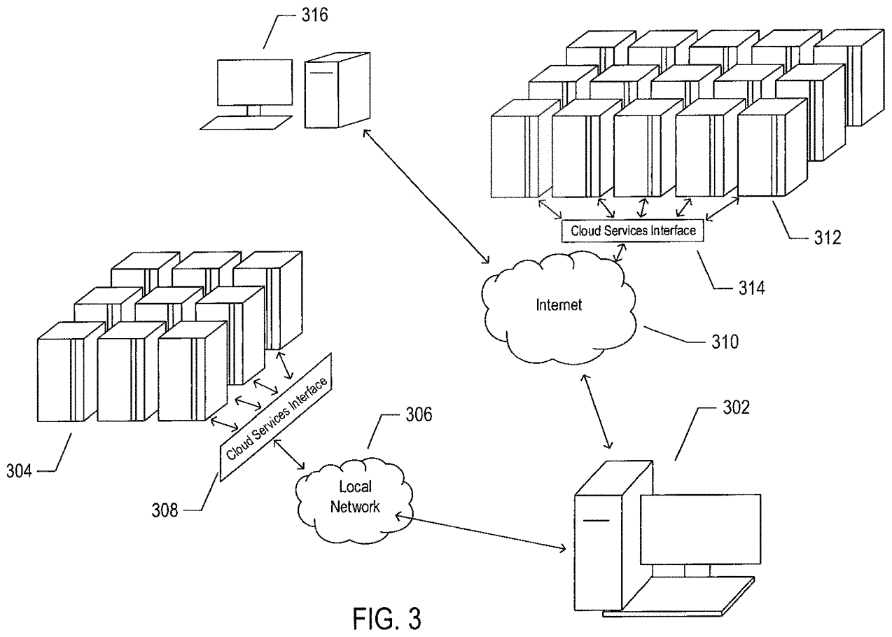

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers perform any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

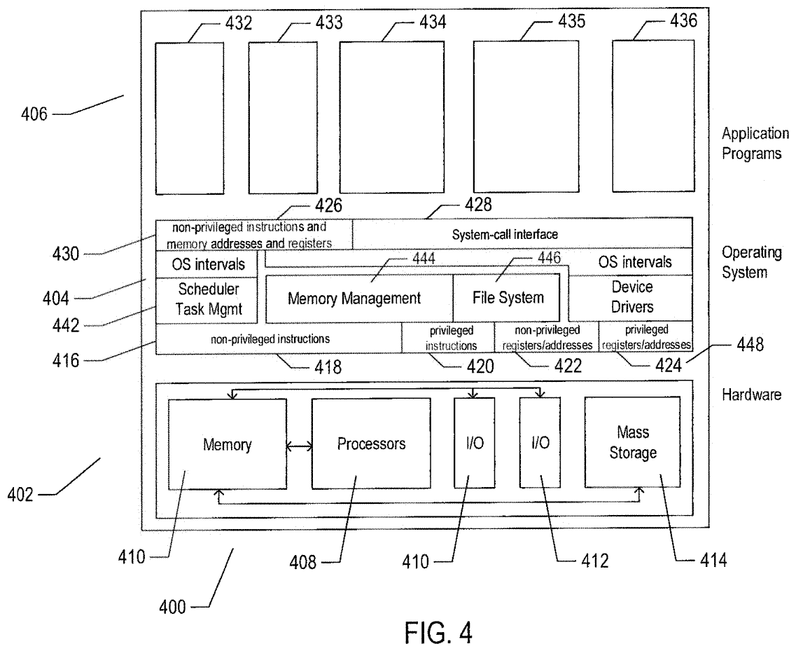

FIG. 4 shows generalized hardware and applications of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I-O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

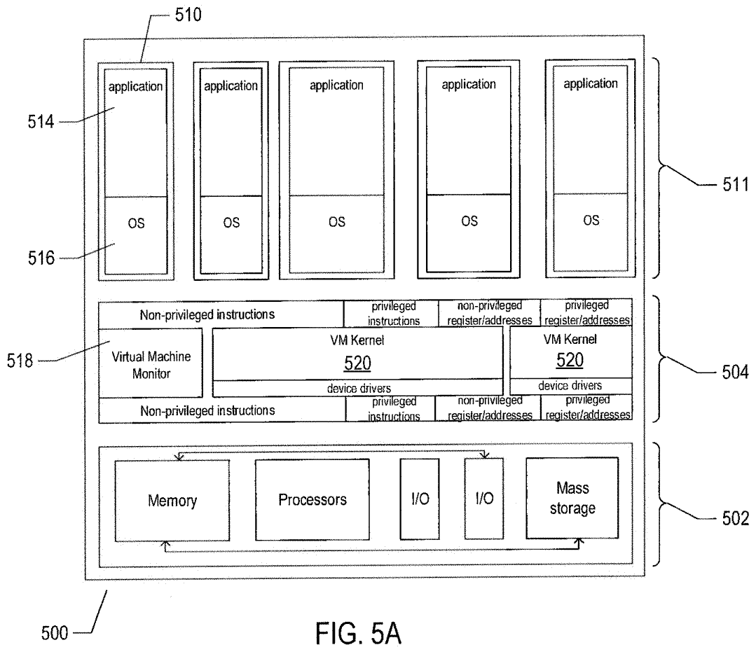

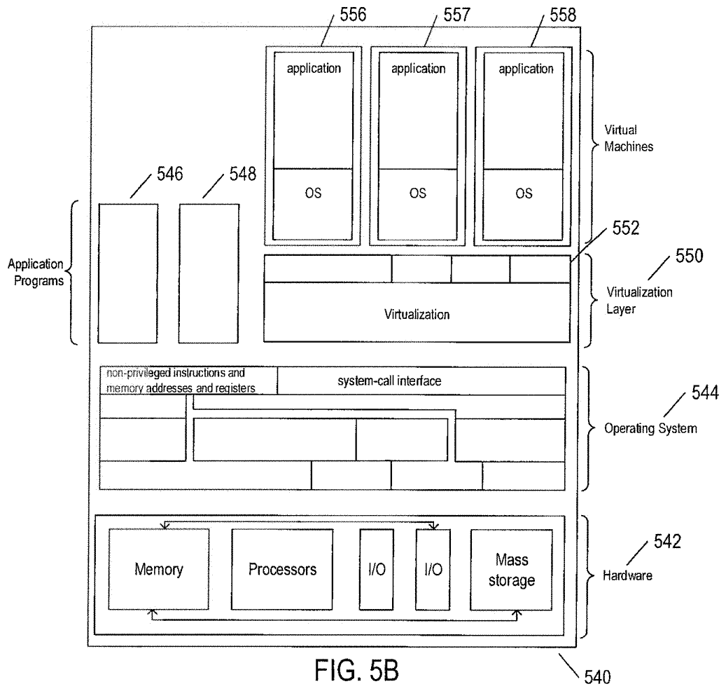

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-13 show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer hardware-layer interface, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system.” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel” The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I-O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 504 in FIG. 5A. The hardware-layer interface 552, equivalent to interface 416 in FIG. 4, provides an execution environment for VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

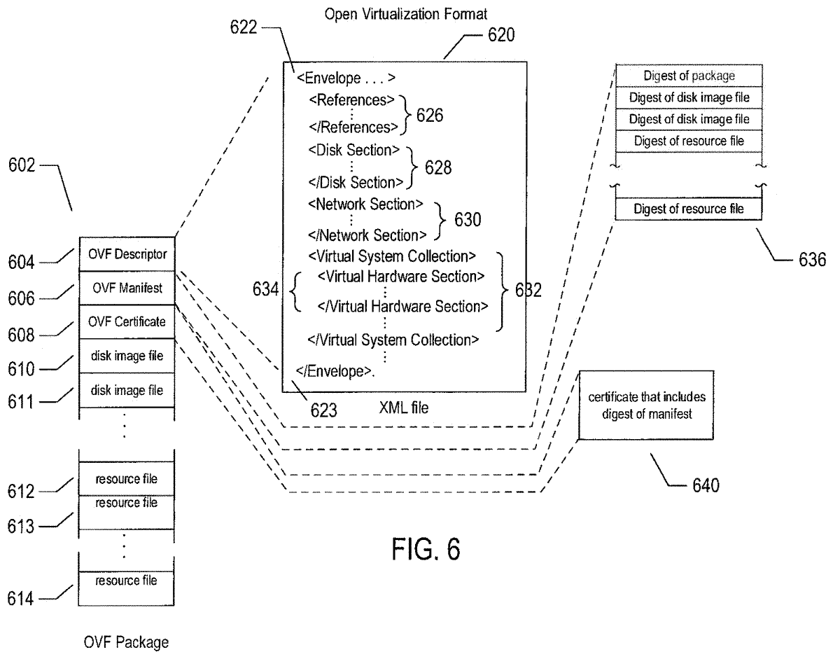

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data tiles. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all the virtual disks included in the OVF package, a network section 630 that includes meta information about all the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

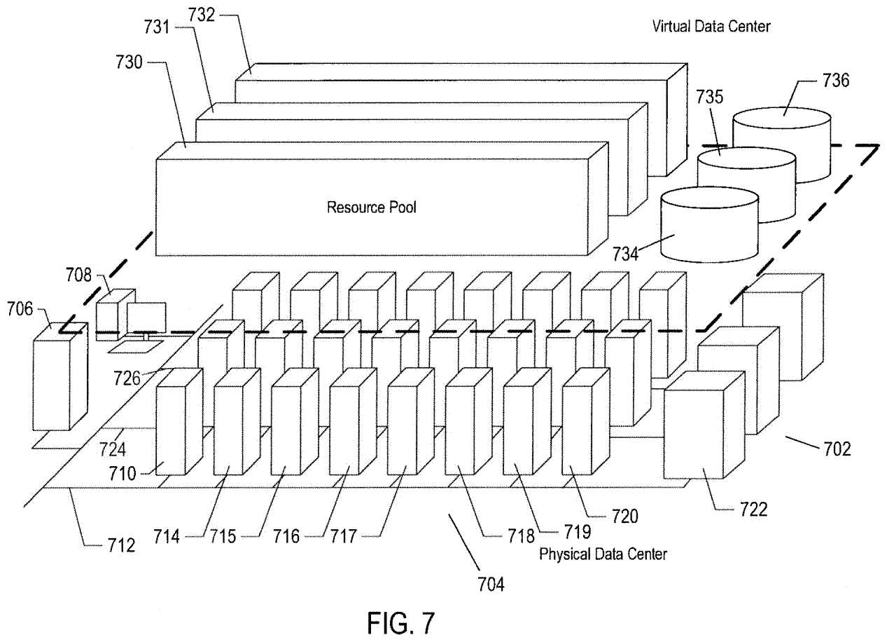

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

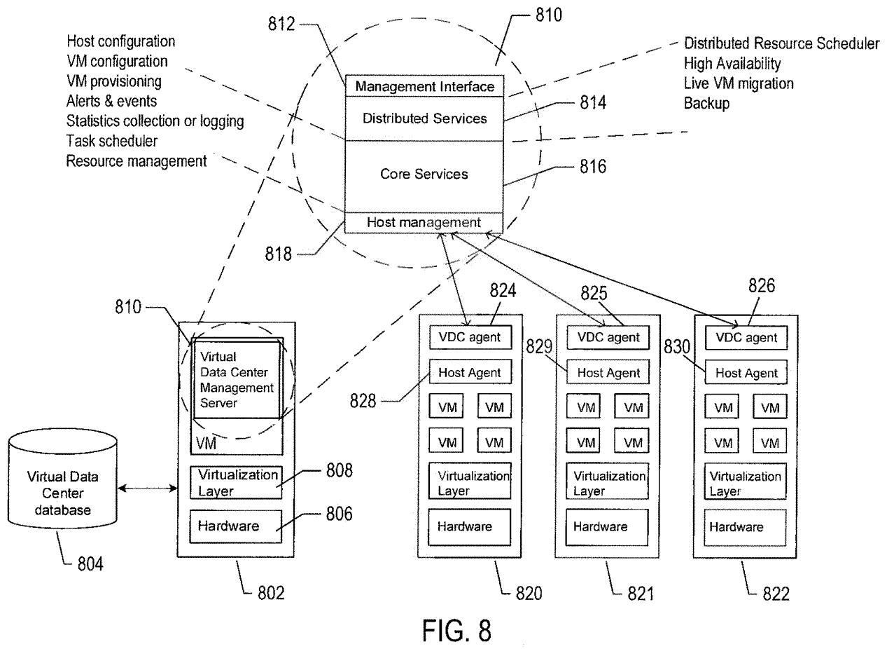

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that V is continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

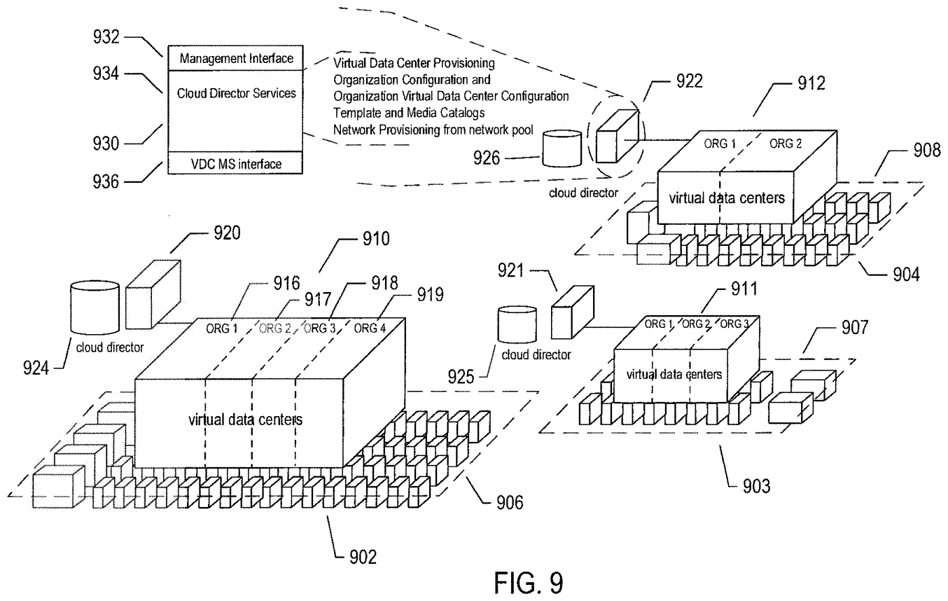

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools, and interfaces for configuring and managing tenant organizations, tools, and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

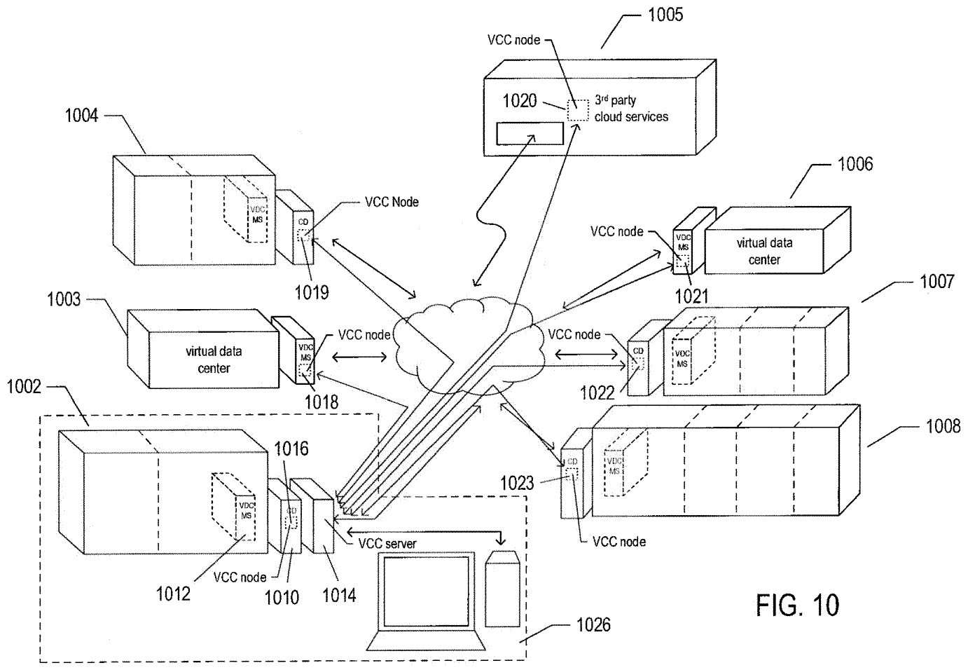

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to large distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

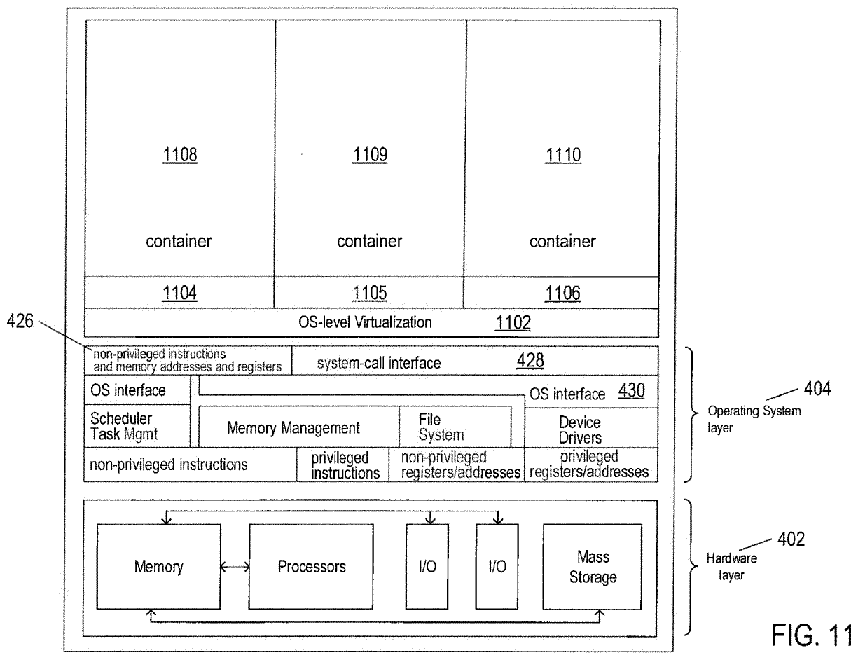

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages over traditional virtualization in addition to the advantages of OSL virtualization. Containers can be quickly booted to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Computer-Implemented Methods for Predicting Behavior of a Distributed Application

A distributed application comprises multiple VMs or containers that run application components simultaneously on one or more host server computers of a distributed computing system. The components are typically executed separately in the VMs or containers. The server computers are networked together so that information processing performed by the distributed application is distributed over the server computers and the VMs or containers can exchange data. The distributed application can be scaled up or down to satisfy changing demands by scaling up or down the number of VMs or containers. As a result, a typical distributed application can process multiple requests from multiple clients at the same time.

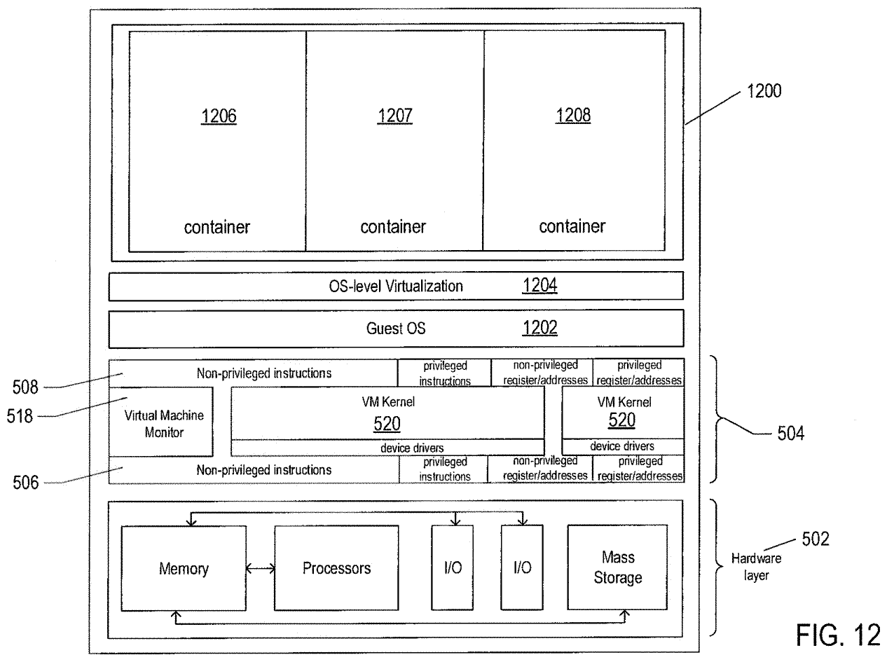

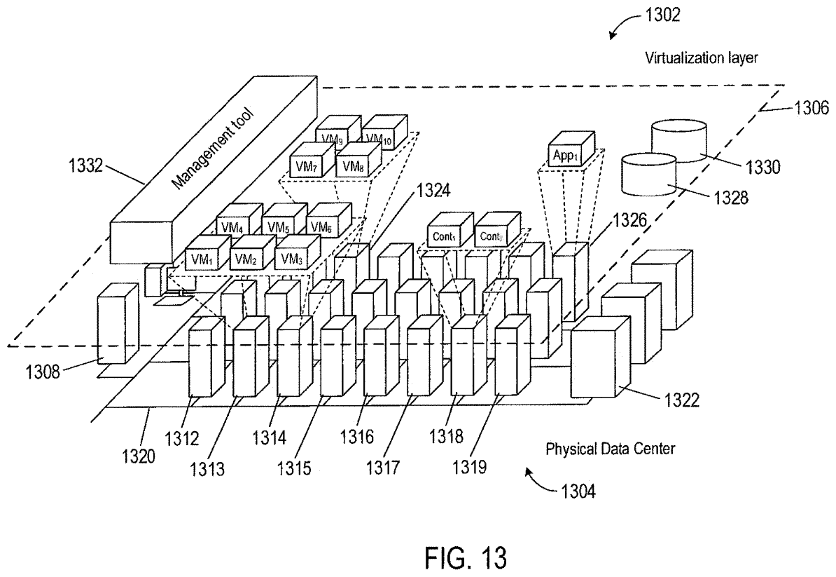

FIG. 13 shows examples of distributed applications in a virtualization layer 1302 that is executed in a physical data center 1304. For the sake of illustration, the virtualization layer 1302 is shown separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed to system administrators and other users, server computers, such as server computers 1312-1319, data-storage devices, and network devices. Each server computer may have multiple network interface cards (“NICs”) that provide high bandwidth and networking to other server computers and data storage devices in the physical data center 1304. The server computers may be networked together to form server-computer groups within the data center 1304. The example physical data center 1304 includes three server-computer groups, each of which have eight server computers. For example, server-computer group 1320 comprises interconnected server computers 1312-1319 that are connected to a mass-storage array 1322 via a switch (not shown). Within each server-computer group, certain server computers are grouped together to form clusters. Each cluster provides an aggregated set of resources, such as processors, memory, and disk space, (i.e., resource pool) to objects in the virtualization layer 1302. Physical data centers are not limited to the example physical data center 1304. Different physical data centers may include many different types of computers, networks, data-storage systems, and devices connected according to many different types of connection topologies.

The virtualization layer 1302 includes virtual objects, such as VMs, applications, and containers, hosted by the server computers in the physical data center 1304. The virtualization layer 1302 also includes a virtual network (not illustrated) comprising virtual switches, virtual routers, virtual load balancers, and virtual NICs formed from the physical switches, routers, and NICs of the physical data center 1304. Certain server computers host VMs and containers as described above. For example, server computer 1318 hosts two containers identified as Cont₁ and Cont₂; cluster of server computers 1313 and 1314 host six VMs identified as VM₁, VM₂, VM₃, VM₄, VM₅, and VM₆; server computer 1324 hosts four VMs identified as VM₇, VM₈, VM₉, VM₁₀. Other server computers may host applications as described above with reference to FIG. 4. For example, server computer 1326 hosts a standalone application identified as App₁.

In FIG. 13, the VMs VM₁, VM₂, VM₃, VM₄, VM₅, and VM₆ form contain application components of a distributed application executed on the cluster of server computers 1313 and 1314. The resources of the server computers 1313 and 1314 provide a resource pool for the six VMs. The VMs enable different software components of the distributed application to run on different operating systems, share the same pool of resources, and share data. The VMs VM₁, VM₂, VM₃, VM₄, VM₅, and VM₆ may provide web services to customers. For example, VM₁ may provide frontend services that enables users to purchase items sold by an owner of the distributed application over the Internet. VMs VM₂-VM₆ execute backend operations that complete each user's purchase, such as collecting money from a user's bank, charging a user's credit card, updating a user's information, updating the owner's inventory, and arranging for products to be shipped to the user. The VMs VM₇, VM₈, VM₉, and VM₁₀ execute a second distributed application on the server computer 1324. Containers Cont₁ and Cont₂ execute components of a third distributed application on the server computer 1318.

A distributed computing environment comprises a distributed application and any hardware components of a distributed computing system used to run the distributed application. For example, a cluster of hosts may be used to run a distributed application. Managing a distributed application involves making changes to the distributed computing environment, such as adding new hosts to a cluster, removing hosts from a cluster, reconfiguring host parameters, such as adding memory, upgrading server software, moving VMs from one host to another, and adding or deleting VMs. Changes to a distributed computing environment are typically implemented to resolve operational issues, such as poor application performance, comply with changes in security policies, plan for future growth, and reclaim wasted resources. However, many of these changes may have unintended consequences. For example, running a backup VM may overload a network and/or data storage devices and create contention for resources, such as CPU and memory, which slows performance of a distributed application. Adding a host to a cluster already running a distributed application in VMs may enable CPU bound VMs to perform more input-output operations per second (“IOPS”), but such a change may overload network capacity and other VMs may perform worse with the additional host.

Because of the complexity of distributed computing environments, it is becoming increasingly more challenging for IT administrators and application owners to predict the impact a change to a distributed computing environment may have on performance of a distributed application. A change that adversely impacts performance of a distributed application is costly to roll back, may cut off users from vital services, may damage an application owner's reputation, or drive customers to a competitor's website. As a result, administrators and application owners that have changed a distributed computing environment with a goal of improving performance of a distributed application but instead caused an unintended service outage are typically reluctant or slow to implement important changes to the distributed computing environment in the future.

Automated computer-implemented methods and systems for predicting behavior of a distributed application in response to changes to a distributed computing environment are described below. The methods and systems use machine learning techniques to automatically learn the behavior of and interaction between objects of a distributed computing environment. The objects include VMs that run software components of the distributed application and hosts that run the VMs. The methods and systems enable users, such as system administrators and application owners, to propose a change (i.e., “What-If scenario”) to a distributed computing environment and predict the impact the proposed change is expected to have on performance of the distributed application.

Computer-implemented methods and systems begin by collecting information about a distributed computing environment at different points in time. The information collected at each point in time is used to generate a corresponding graph that models the state of the distributed computing environment at the point in time. Nodes of the graph represent objects in the distributed computing environment, edges represent relationships between the objects, node labels represent operational data about the object (e.g., configuration, properties, and metrics), and certain node outputs are KPIs of the distributed application. Machine learning methods described below use the graphs collected over time to train a neural-network (“NN”) model of the distributed computing environment. A user proposes a change to the distributed computing environment in the form of a What-if scenario. The NN model outputs predicted KPIs that represent how the distributed application is expected to respond to the What-if scenario. The predicted KPIs can be compared with current KPIs of the distributed application to determine whether the proposed change is benign, beneficial, or detrimental to performance of the distributed application.

The methods and systems described herein aid administrators and application owners with gaining confidence in executing proposed changes to their distributed computing environment by providing users with accurate predictions of how the distributed application is expected to behave in response to the proposed changes. Such predictions reduce the possibility of making an adverse change to the distributed computing environment, increase the rate at which administrators and application owners make useful changes, and reduces wasted resources. As a result, administrators and application owners are less likely to over- or under-provision a distributed computing environment and are more likely to reclaim idle resources.

Data Collection

Computer-implemented methods and systems collect various types of data about a distributed computing environment at a series of points in time called “time stamps.” The various types of data collected at each time stamp includes

(1) infrastructure inventory of the objects comprising the distributed computing environment, such as clusters, hosts, VMs, network elements, storage elements, applications comprising a distributed application, and other objects in the distributed computing environment;

(2) virtual and physical object configurations, such as number of cores, amount of memory, and disk space;

(3) object relationships, such as how each object is related to one or more other objects in the distributed computing environment;

(4) operational metrics of the objects, such as CPU usage, CPU contention, CPU wait time, memory usage, network bandwidth, storage bandwidth, and latency:

(5) application inventory, such as applications running in the VMs, metadata that describes how VMs are organized into a distributed application (e.g., a shopping application may comprise load-balancer VMs, application server VMs, message queue VMs, cache VMs, and database VMs); and

(6) application key performance indicators (“KPIs”) are retrieved from the data-storage device. A KPI is a metric that indicates or represents the performance level of a distributed application. For example, a KPI for a shopping distributed application could be the number of shopping carts successfully closed per hour. A KPI for a website may be response times to customer requests.

The process of collecting data about a distributed computing environment is executed by the management tool 1332 using any of various application programming interfaces (“APIs”). For example, the data may be collected using APIs in VMware's vCenter®, which is a management utility that manages VMs, hosts, and dependent components from a single centralized location, such the management tool 1332. After the data has been collected, the data is transmitted from the source to an ingestion service which processes the data and persists the data in a database.

The management tool 1332 receives metrics from the objects of distributed computing environment. Each metric is a stream of time series data that may be generated by an operating system, a resource, an operating system, or by an object itself. A stream of metric data comprises a sequence of time-ordered metric values recorded in spaced points in time called “time stamps” and is denoted by

(yⱼ)ⱼ₌₁^{N}=(y(tⱼ))ⱼ₌₁^{N} (1)

where
N is the number of metric values in the sequence;
yⱼ=y(tⱼ) is a metric value;
tⱼ is a time stamp indicating when the metric value was recorded in a data-storage device; and
subscript j is a time stamp index j=1, . . . , N.

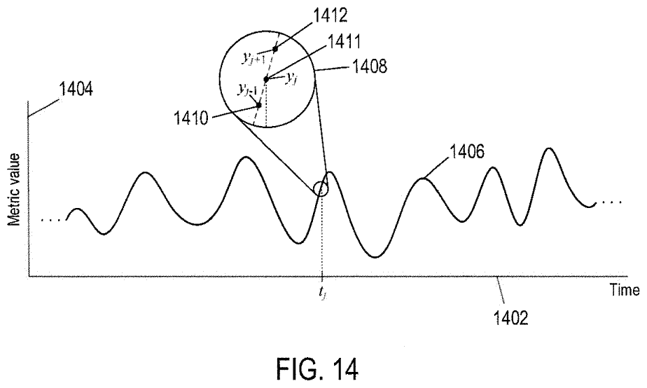

FIG. 14 shows a plot of an example metric. Horizontal axis 1402 represents time. Vertical axis 1404 represents a range of metric value amplitudes. Curve 1406 represents a metric as time series data. In practice, a metric comprises a sequence of discrete metric values in which each metric value is recorded in a data-storage device. FIG. 14 includes a magnified view 1408 of three consecutive metric values represented by points. Each point represents a value of the metric at a time stamp. For example, points 1410-1412 represent consecutive metric values yⱼ₋₁, yⱼ, and yⱼ₊₁ and recorded in a data-storage device at corresponding time stamps tⱼ₋₁, tⱼ, and tⱼ₊₁. The metric 1406 may represent usage of a physical or virtual resource. For example, the metric may represent CPU usage of a core in a multicore processor of a server computer over time. The metric may represent the amount of virtual memory used by a VM over time. The metric may represent network throughput for a server computer. The metric may represent network traffic for a server computer. The metric may also represent a KPI, such as CPU contention, response time to requests, number of operations completed per unit time, and wait time for access to an object or an application of a distributed application.

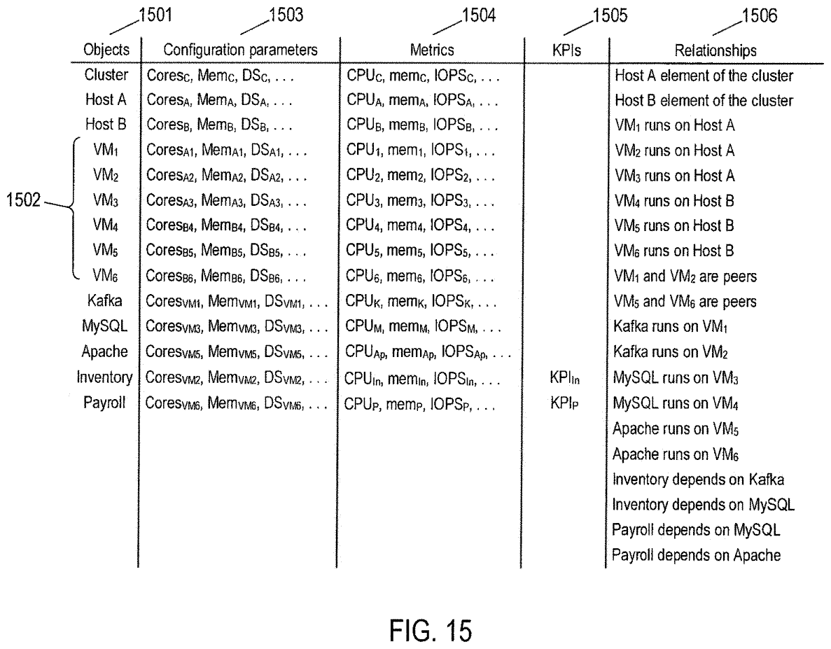

FIG. 15 shows a table of the type of data collected by the management tool 1332 for an example distributed application executed with the six VMs VM₁, VM₂, VM₃, VM₄, VM₅, and VM₆ shown in FIG. 13. Column 1501 lists objects of a distributed computing environment. For example, hosts Host A and Host B correspond to server computers 1313 and 1314 in FIG. 13. VMs 1502 are the VMs VM₁, VM₂, VM₃, VM₄, VM₅, and VM₆ shown in FIG. 13. Kafka, MySQL, Apache, Inventory, and Payroll are software components that form the example distributed application and are run in the six VMs. Column 1503 list configurations of the hosts and VMs listed in column 1401. For example, Cores_{C}, Mem_{C}, and DS_{C} represent the total number of cores, total amount of memory, and total disk space, respectively, of the server computers Host A and Host B that form the cluster. For example, the total number of cores. Cores_{C}, is a sum of the Cores_{A} and Cores_{B} of the hosts Host A and Host B. In this example, VM₁, VM₂, and VM₃ run on Host A and VM₄, VM₅, and VM₆ run on Host B. Cores_{A1}, Mem_{A1}, and DS_{A1} represent the number of cores, amount of memory, and disk space, respectively, of the Host A assigned to VM₁. Cores_{B4}, Mem_{B4}, and DS_{B4} represent the number of cores, amount of memory, and disk space, respectively, of the Host B assigned to VM₄. Column 1504 list metrics associated with the objects listed in column 1401. The metrics include CPU usage, memory, and IOPS of each object. For example, CPU_{M}, Mem_{M}, and IOPS_{M} represent CPU usage, memory usage, and IOPS, respectively, by MySQL. The metrics may also include CPU wait time, latency, storage bandwidth, and network bandwidth. Column 1505 list two KPIs denoted by KPI_{In} and KPI_{P} for the Inventory and Payroll software components, respectively. KPI_{In} and KPI_{P} represent the performance level of corresponding Inventory and Payroll software components and are used as described below to determine how performance of the example distributed application is affected by a change to the distributed computing environment of the distributed application. For example, KPI_{In} and KPI_{P} may represent response times to user requests or represent the number of operations performed by the corresponding Inventory and Payroll components per unit time. Column 1506 list relationships between the objects. For example, the cluster comprises hosts Host A and Host B, Host A runs VM₁, VM₂, and VM₃, and Apache run in VM₅ and VM₆. The data shown in FIG. 15 is an example of the type of information about the state of a distributed computing environment that is collected for each time stamp of a time period.

Graph Generation

Computer-implemented methods and systems use the data collected about a distributed computing environment at each time stamp to construct a corresponding graph. Each graph represents the state of the distributed computing environment at each time stamp. A graph is represented by

G=(Ñ,\tilde{L},\tilde{E},Õ) (2)

where
Ñ={n₁, . . . , n_{d}} is a set of nodes and subscript d is the number of nodes in the graph (i.e., number of objects in the distributed computing environment);
\tilde{L}={l₁, . . . , l_{d}} is a set of node labels;
\tilde{E} is a set of edges, such that e_{(α,β)}∈\tilde{E} denotes an edge connecting nodes n_{α} and n_{β}; and
Õ={o₁, . . . , o_{d}} is a set of node outputs.
   A node nᵢ in the set of nodes Ñ represents an object of the distributed computing environment, such as a physical object or a virtual object of the distributed application. A node label lᵢ in the set of node labels \tilde{L} represents the configuration and metrics of the object represented by the node nᵢ at the time stamp tⱼ. The output oᵢ is a metric associated with the node nᵢ. For example, the output oᵢ may be a KPI that represents performance of the node nᵢ at the time stamp tⱼ. An edge e_{(α,β)} in the set of edges \tilde{E} represents a relationship, or connection, between two nodes n_{α} and n_{β} at the time stamp tⱼ.

The set of edges \tilde{E} translate to an adjacency matrix A for the graph G with matrix elements given by

$${a}_{( α , β )} = \{ \begin{matrix}0 & {e}_{( α , β )} ∉ E \\ 1 & {e}_{( α , β )} ∈ E\end{matrix} \qquad ( 3 )$$

The adjacency matrix A is an d×d square symmetric matrix. The set of node labels form an d×k node label matrix:

$$L = [ \begin{matrix}{l}_{1} \\ ⋮ \\ {l}_{d}\end{matrix} ] = [ \begin{matrix}{l}_{11} & … & {l}_{1 k} \\ ⋮ & ⋱ & ⋮ \\ {l}_{d 1} & … & {l}_{dk}\end{matrix} ] \qquad ( 4 )$$

where k is the number of configuration parameters and metrics of the node labels.

Each row of the node label matrix L comprises the node labels associated with a node in the graph G. For example, node label lᵢ comprises an ordered sequence of configuration parameters and metrics [lᵢ₁, lᵢ₂, lᵢ₃, . . . , l_{iK}] of node nᵢ. Suppose node nᵢ represents a VM, then lᵢ₁, lᵢ₂, and lᵢ₃ may represent the number of cores, amount of memory, and disk space assigned to the VM, and lᵢₖ may represent CPU usage of the VM.

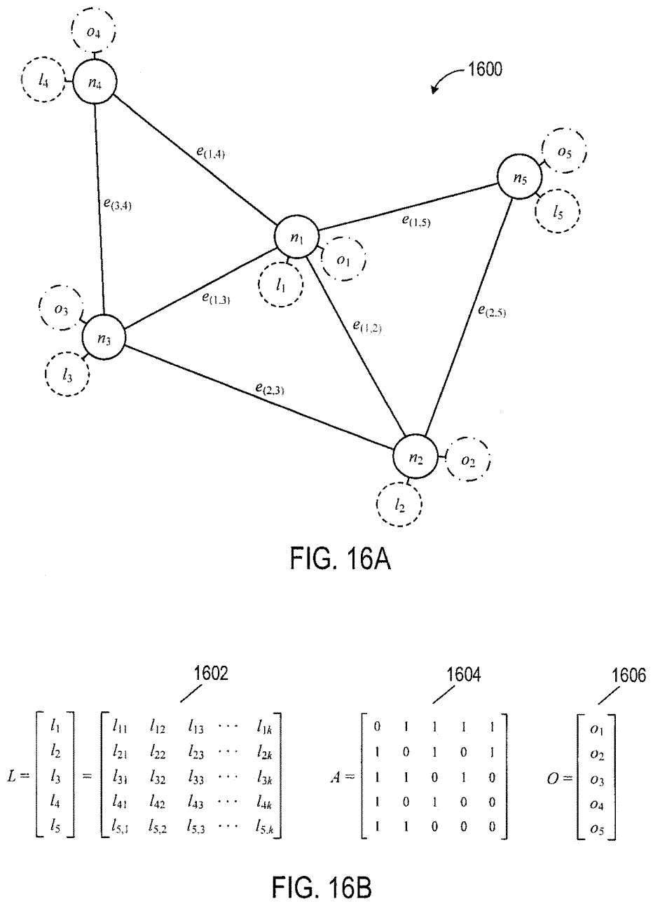

FIG. 16A shows an example graph 1600 comprising five nodes (i.e., d=5) and seven edges. Each node represents an object of a distributed computing environment. Edges represent a relationship between nodes. Each node also includes an associated node label and output. For example, node n₁ is connected to nodes n₂, n₃, n₄, and n₅ as represented by edges e_{(1,2)}, e_{(1,3)}, e_{(1,4)}, and e_{(1,5)}. Node n₁ may represent, for example, a server computer and nodes n₂, n₂, n₄, and n₅ may represent four VMs that run on the node n₁. Each node also has a corresponding node label and output. For example, node label l₁ represents the configuration and metrics of node n₁, and o is a KPI of node n₁.

FIG. 16B shows an example node label matrix 1602 for the distributed computing environment represented by the graph 1600. Each node label comprises k configuration parameters and metrics associated with a node of the graph. For example, node label l₁ represents the k configuration parameters and metrics [l₁₁, l₁₂, l₁₃, . . . , l₁ₖ] of the node n₁ which appear in the first row of the node label matrix L. For example, if node n₁ is a VM, l₁₁ may represent the number of cores assigned to the VM, l₁₂ may represent the amount of memory assigned to the VM, and l₁₃ may represent disk space assigned to the VM and so on. FIG. 16B shows an adjacency matrix A 1604 for the graph 1600. The adjacency matrix A is a square symmetric matrix in which matrix elements that are equal to one correspond to edges in the graph 1600. For example, edge e_{(1,2)} in the graph 1600 corresponds to nonzero matrix elements a_{(1,2)} 1604 and a_{(2,1)} 1606 in the adjacency matrix A 1602. Zero value matrix elements in the adjacency matrix A indicate there is no corresponding edge in the set of edges E. FIG. 16B shows an output column matrix 1606 of the outputs from the nodes in the graph 1600. The output 1606 may be metric values of metrics of the corresponding nodes at a time stamp, such as KPI metric values at the time stamp. Note that in practice the output 1606 may be composed of selected KPIs that are used to determine how the performance of a distributed application would be changed in response to a change to the distributed computing environment of the distributed application.

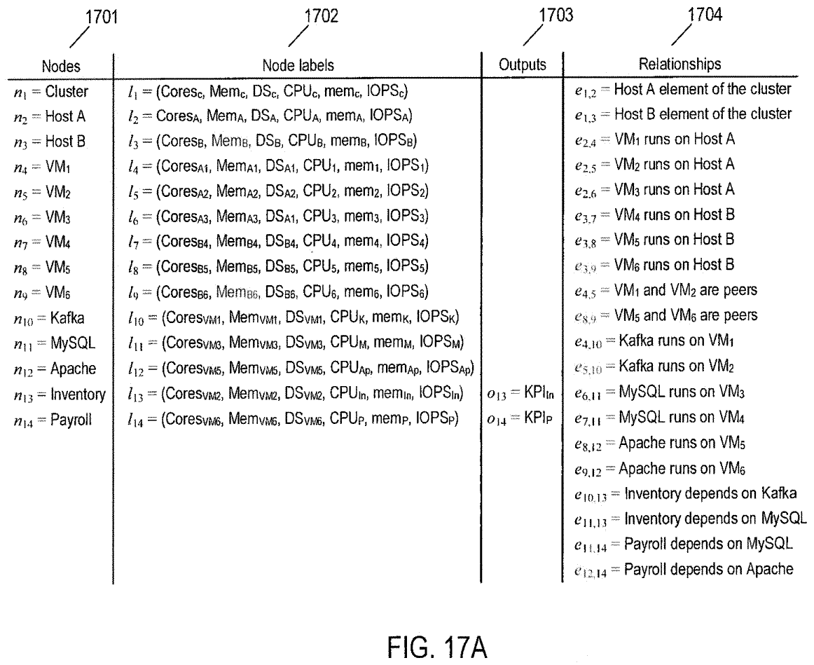

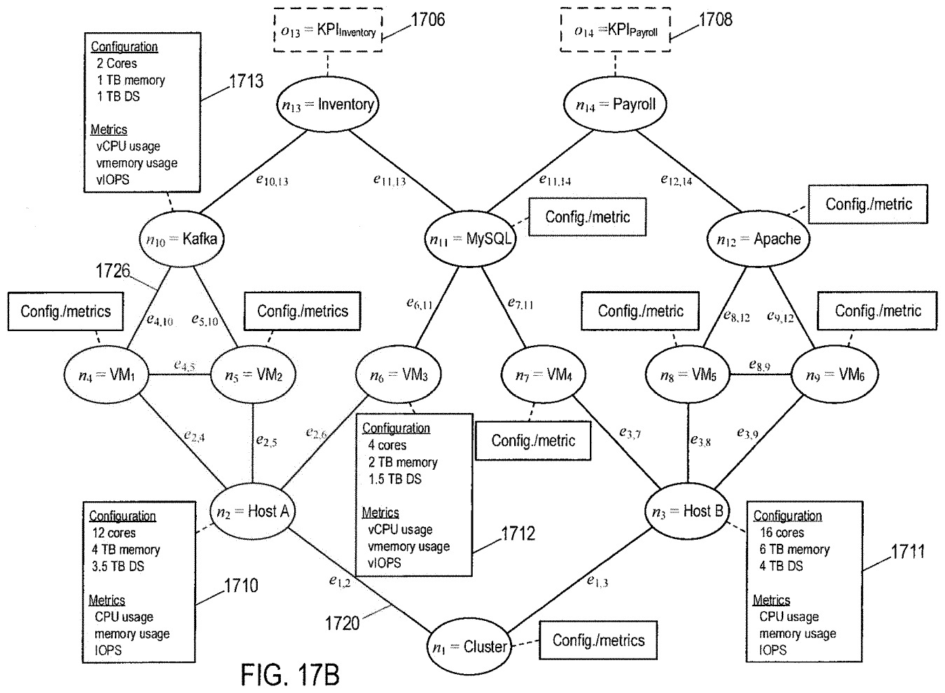

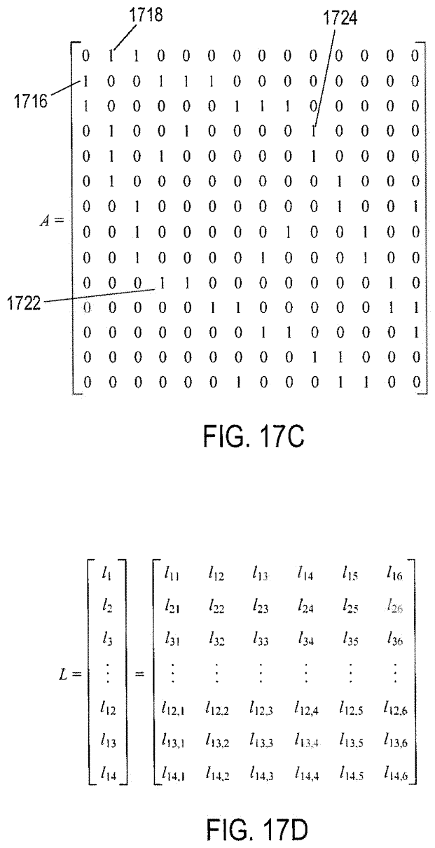

FIGS. 17A-17E show an example graph, symmetric matrix, node label matrix, and outputs, respectively, constructed from the collected data shown in FIG. 15. In the following discussion. FIGS. 17A-17E serves as an example for describing various implementations of the methods and systems for predicting the behavior of a distributed application based on proposed changes to the distributed computing environment.

FIG. 17A shows an example table of nodes, node labels, outputs and edges for a graph formed from the objects, configurations, metrics, outputs, and relationships of the collected data shown in FIG. 15. The nodes listed in column 1701 correspond to the objects listed in column 1502 of FIG. 15. The node labels in column 1702 are formed from the configuration parameters and metrics in columns 1503 and 1504 of FIG. 15. The outputs in column 1703 are the KPIs in column 1505 of FIG. 15 and have been selected by the user to evaluate performance of the distributed application. The set of edges in column 1704 are formed from the relationships between objects listed in column 1506 of FIG. 15.

FIG. 17B shows an example graph formed from the nodes, node labels, edges, and outputs listed in the table of FIG. 17A. The nodes are represented by ovals and the outputs KPI_{In} and KPI_{P} are represented by dashed rectangles 1706 and 1708, respectively. Rectangles next to the nodes n₁ through n₁₂ are the node labels formed from the configuration parameters and metrics associated with the nodes. The graph includes expanded examples of node labels 1710-1713 associated with the nodes n₂, n₃, n₆, and n₁₀.

FIG. 17C shows an adjacency matrix A formed from the set of edges of the graph shown in FIG. 17B according to Equation (3). For example, matrix elements a_{(2,1)} 1716 and a_{(1,2)} 1718 correspond to edge e_{(1,2)} 1720 in FIG. 17B. And matrix elements a_{(10,4)} 1722 and a_{(4,10)} 1724 correspond to edge e_{(4,10)} 1726 in FIG. 17B. The adjacency matrix A is a square symmetric 14×14 matrix.

The set of node labels in FIG. 17B form a node label matrix shown in FIG. 17D. For example, the node labels l₂ of node n₂ (i.e., Host A in FIG. 17B) are equated as follows: l₂₁ is 12 cores, l₂₂ is 4 TB of memory, l₂₃ is 3.5 TB of disk space, l₂₄ is CPU usage at the time stamp, l₂₅ is memory usage at the time stamp, and l₂₆ is the number of IOPS at the time stamp. Note that zeros may be used to pad node labels where no data has been collected.

The graph displayed in FIG. 17B is an example of a graph constructed in accordance with Equation (2). The graph shows a set of nodes, a set of node labels, a set of edges, and a set of outputs of a distributed computing environment of a distributed application. Computer-implemented methods and systems use the node label matrix L, adjacency matrix A and the output matrix O of graphs formed over numerous time stamps to train an NN model that can be used to predict behavior of a distributed application in response to changes in a distributed computing environment. Given that a set of edges \tilde{E} for a graph G is represented by the adjacency matrix A and the set of nodes Ñ is including in the set of node labels \tilde{L}, the graph in Equation (2) may equivalently be represented by

G=(L,A,O) (5)

Computer-implemented methods and systems predict behavior of a distributed application in response to changes to a distributed computing environment in which the distributed application is executed are described below with reference to the node label matrix L, adjacency matrix A, and output matrix O of the graph G in Equation (5).

FIG. 17E shows an example of a graph that is an alternative representation of the graph shown in FIG. 17B. The nodes of the graph shown in FIG. 17E are labeled by corresponding node labels of the node label matrix L. The edges of the graph shown in FIG. 17E are labeled by the corresponding elements of the adjacency matrix A. The outputs o₁₃ and o₁₄ represent the KPI_{In} and KPI_{P} in FIG. 17B, respectively.

In the following discussion, graph learning is described with reference to the graph G=(L, A, O) rather than corresponding graph G=(Ñ, \tilde{L}, \tilde{E}, Õ). Graph learning described below is performed with the node label matrix L, the adjacency matrix A. and the output matrix O of a graph G of a distributed computing environment.

Graph Learning

Because a distributed computing environment changes over time, the graph G representing the distributed computing environment at different time stamps also changes over time. Changes can be in the form of adjusting configurations of objects, such as allocating additional cores to a VM or increasing memory to a VM. Changes may include adding VMs to, or removing VMs from, a host, or adding hosts to, or removing hosts, from a cluster. As a result, a graph of a distributed computing environment constructed at one point in time may be similar to but, in general, different from a graph of the same distributed computing environment at a different point in time.

Computer-implemented methods and systems construct a graph from data collected for a distributed computing environment at each time stamp of a period of time. The graph can be represented by G^{j}=(L^{j}, A^{j}, Oⱼ), where superscript j corresponds to the time stamp tⱼ. The node label matrix L^{j} comprises the configuration parameters and metrics of the set of nodes at the time stamp tⱼ. The adjacency matrix A^{j} represents relationships between the set of nodes at the time stamp tⱼ. The output Oⱼ represents selected outputs (e.g., KPIs) from selected nodes at the time stamp tⱼ. The graphs collected at a series of time stamps over a period of time form a training set denoted by:

Ω={G¹, . . . ,G^{j}, . . . ,G^{T}} (6)

where superscript “T” is the number of graphs in the training set and corresponds to the T-th time stamp t_{T}.

Each graph in the training set Ω of Equation (6) is constructed from data collected about the same distributed computing environment at T time stamps in the period of time.

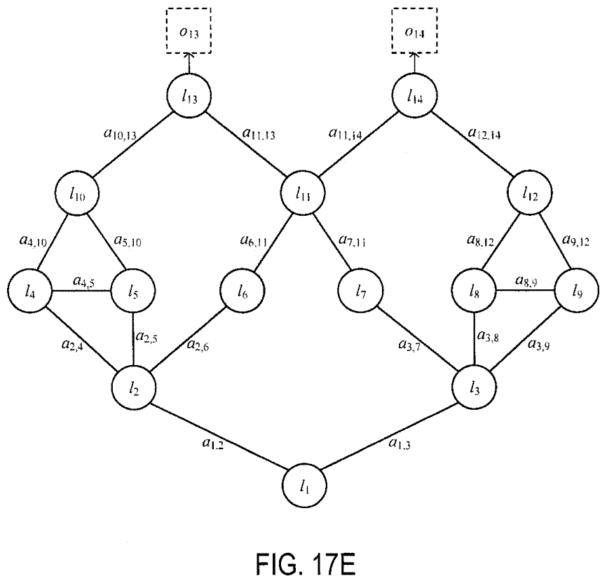

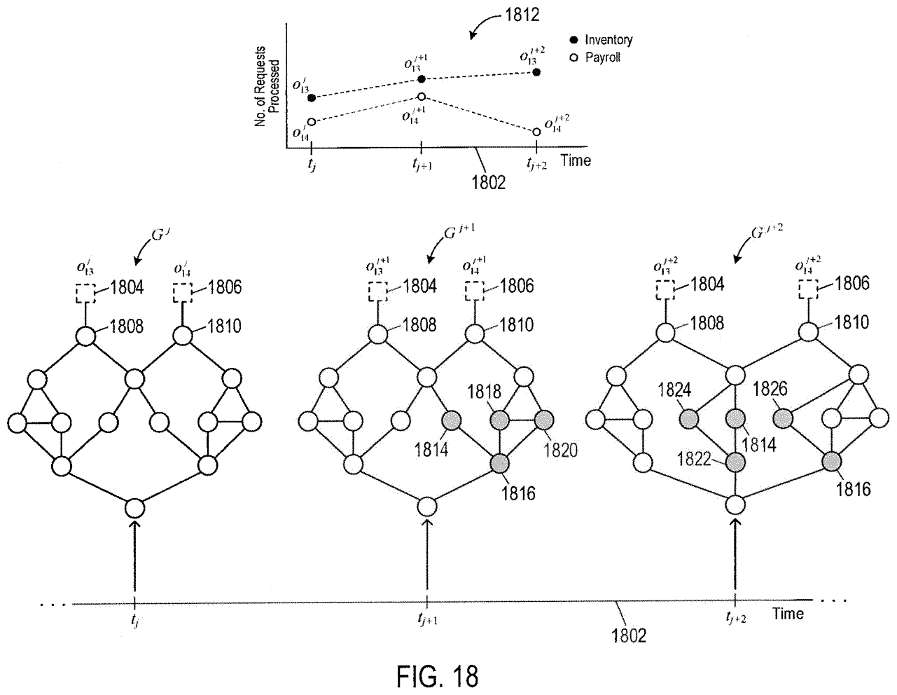

FIG. 18 shows an example of three consecutive graphs of a training set for the example distributed computing environment represented by the graph in FIG. 17E. Horizontal line 1802 represents a time axis. Marks along the time axis 1802 denoted by tⱼ, tⱼ₊₁, and tⱼ₊₂ represent three consecutive time stamps. Graphs G^{j}, G^{j+1}, and G^{j+2} are constructed from data collected for the distributed computing environment at the corresponding time stamps tⱼ, tⱼ₊₁, and tⱼ₊₂ as described above with reference FIGS. 15 and 17A-17E. The graphs G^{j}, G^{j+1}, and G^{j+2} represent graphs in a training set Ω. Gray colored nodes represent changes to corresponding objects of the distributed computing environment. Suppose KPI_{In}, and KPI_{P} represented by corresponding outputs 1804 and 1806 are the number of requests processed per unit time by corresponding Inventory and Payroll components represented by corresponding nodes 1808 and 1810. FIG. 18 includes a plot 1812 of example outputs 1804 and 1806 at each of the time stamps tⱼ, tⱼ₊₁, and tⱼ₊₂. The graph G^{j} produces outputs o₁₃^{j} and o₁₄^{j} at time stamp tⱼ represented in the plot 1812. At time stamp tⱼ₊₁, the graph G^{j+1} shows changes to nodes 1814, 1816, 1818, and 1820. Suppose the changes are an increase in the amount of memory of node 1816 (i.e., Host B) allocated to VMs represented by nodes 1814, 1818, and 1820. This change increases the number of requests processed by the Inventory and Payroll components 1808 and 1810 per unit time, as indicated by corresponding outputs o₁₃^{j+1} and o₁₄^{j+1} at time stamp tⱼ₊₁ in the plot 1812. At time stamp tⱼ₊₂, the graph G^{j+2} shows a change to node 1816 and addition of a new host represented by node 1822. Node 1814 has been migrated to new node 1822. New VMs have been added as represented by nodes 1824 and 1826. These changes increase the number of requests processed by the Inventory component 1808 and decrease the number of requests processed by the Payroll component 1810 per unit time, as indicated by corresponding outputs o₁₃^{j+2} and o₁₄^{j+2} at time stamp tⱼ₊₂ in the plot 1812.

Computer-implemented methods and systems use the training set f to train an NN model that can be used to predict how a change to a distributed computing environment of a distributed application will change the performance of the distributed application. Different techniques may be used to train an NN model for predicting how such a change is expected to alter the performance of a distributed application.

In one implementation, the training set Ω is used to train a graph neural network (“GNN”) model. The objective of a GNN model is to learn a state xₙ∈ [symbol] ^{s} for each node n of a graph based on the information associated with nodes of the graph that are neighbors of the node n, where [symbol] ^{s} denotes an s-dimensional real-valued vector. The state xₙ contains a representation of the node n and can be used to produce an output oₙ, such as a KPI. Let h_{w} be a parametric function that expresses a dependence of the node n on its neighborhood of nodes and let g_{w} be a local output function that describes how output oₙ associated with the node n is produced, where subscript w denotes a set of weights (i.e., w={w₁, . . . , w_{D}}). The state and output are defined as follows:

$${x}_{n} = {\sum }_{u ∈ n e [ n ]} {h}_{w} ( {l}_{n} , {x}_{u} , {l}_{u} ) \qquad ( 7 a )$$

$${o}_{n} = {g}_{w} ( {x}_{n} , {l}_{n} ) \qquad ( 7 b )$$

where ne[n] is a set of indices of neighboring nodes of node n.

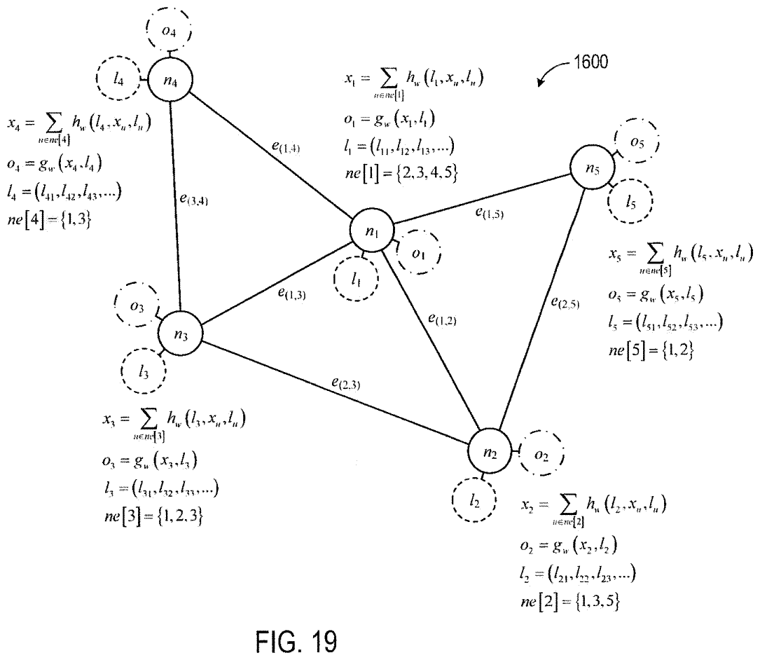

FIG. 19 shows state functions and outputs for the nodes of the graph shown in FIG. 16A. For example, node n₂ has neighboring nodes n₁, n₃, and n₅. The node label l₂ is described above with reference to FIG. 16B and the set of indices ne[2] comprises the indices for the neighboring nodes.

Let [symbol] , [symbol] , and [symbol] _{N} be vectors constructed from stacking all states, outputs, and node labels, respectively. As a result, Equations (7a) and (7b) can be rewritten in a compact form:

[symbol]

=F_{w}( [symbol] , [symbol] _{N}) (8a)

[symbol]

=G_{w}( [symbol] , [symbol] _{N}) (8b)

Determining a GNN model defines a parametric function φ_{w}:G→ [symbol] ^{m}, which is an approximation of G_{w} in Equation (8b). The parametric function φ_{w} takes as input a graph G and for each node returns a predicted output oₙ^{p}, where superscript “p” denotes a predicted output such as predicted KPI output for node n. Learning a GNN model comprises estimating the set of weights w, such that φ_{w} approximates the data in the training set. The learning task can be posed as minimization of a quadratic cost function:

$${e}_{w} = {\sum }_{j = 1}^{T} {\sum }_{i = 1}^{{d}_{j}} {( {o}_{j , i} - {φ}_{w} ( {G}^{j} , {n}_{j , i} ) )}^{2} \qquad ( 9 )$$

where
dⱼ is the number of nodes in the graph G^{j};
n_{j,i} is the i-th node in the graph G^{j}; and
o_{j,i} is the target output from the node n_{j,i}.
   The learning algorithm is based on a gradient-decent strategy: (1) the states xₙ of the nodes are iteratively updated until the states approach a fixed-point solution; (2) the gradient ∂e_{w}/θw is computed; and (3) the weights it are updated according to the gradient computed in step (2). Techniques for performing gradient decent are described in “The Graph Neural Network Model” by F. Scarselli, A. C. Tsoi, and G. Monfardini, IEEE Transactions on Neural Networks, Vol. 20, No. 1, January 2009.

For a linear GNN, the function in Equation (7a) is given by

h_{w}(lₙ,xᵤ,lᵤ)=B_{n,u}xᵤ+bₙ (10)

where
bₙ∈ [symbol] ^{s}; and
matrix B_{n,u}∈ [symbol] ^{s×s} are the output of two feedforward neural networks with parameters that correspond to parameters of the GNN.
   Let ϕ_{w}: [symbol] ^{2l}^{_{N}}→ [symbol] ^{s}^{²} and ρ_{w}: [symbol] ^{l}^{_{N}}→ [symbol] ^{s} be the functions implemented by two multilayer feedforward neural networks such that B_{n,u}=(μ/s[ne[u]])·resize(ϕ_{w}(lₙ, lᵤ)) and bₙ=ρ_{w}(lₙ), where μ∈(0,1) and resize(·) is an operator that allocates the elements of an s²-dimensional vector to an s×s matrix. The function ϕ_{w} may be a hyperbolic tangent and ρ_{w} may be a forcing function.

For a non-linear GNN, h_{w}(lₙ, xᵤ, lᵤ) may be implemented by a feedforward NN with the requirement that the global transition function F_{w} in Equation (8a) be a contraction as described in the reference “The Graph Neural Network Model.” Alternative methods for constructing GNN models are described in “A comprehensive survey on Graph Neural Networks,” Z. Wu, F. Chen. C. Zhang, and P. S. Yu. Journal of Latex Class Files, August 2019.

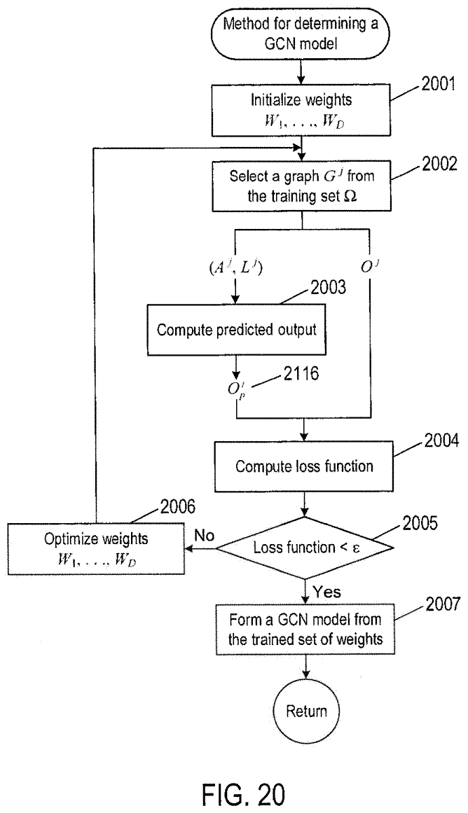

In another implementation, the training set Ω is used to train weights of a graph convolution network (“GCN”) model. FIG. 20 is a flow diagram of a process of training weights of GCN model. In block 2001, a set of weight matrices {W₁, . . . , W_{D}} are initialized, where D is the number of layers in the GCN. The weights of the weight matrices may initially be assigned random values or the weights may all be assigned the same value. In block 2002, a graph G^{j} is selected from the training set Ω. Graphs may be randomly selected from the training set Ω or systematically selected from the training set Ω. The adjacency matrix A^{j} and the node label matrix L^{j} are used in block 2003 to compute a predicted output Oₚ^{j}.

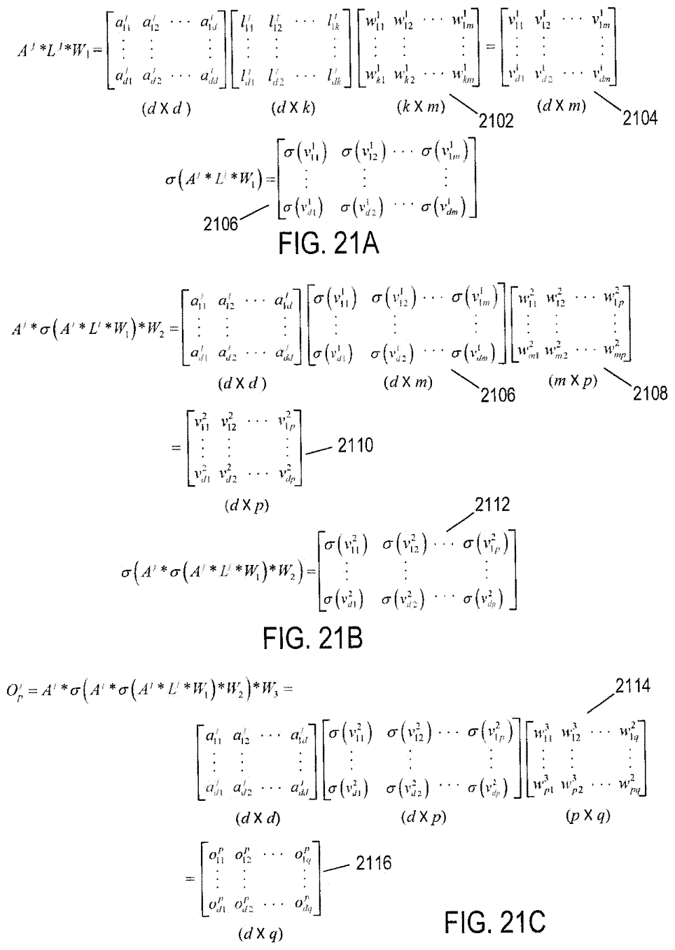

FIGS. 21A-21C show a process of determining a predicted output Oₚ^{j} from the adjacency matrix A^{j} and the node label matrix L^{j} in a three-layer GCN executed in block 2003. In FIGS. 21A-21C, the dimensions of the matrices are shown below the matrices and “*” is an operator that represents matrix multiplication. In FIG. 21A, a product A^{j}*L^{j}*W₁ is obtained by multiplying node label matrix L^{j} on the left by the adjacency matrix A^{j} and on the right by a first weight matrix W₁ 2102 to obtain a matrix 2104. The weight matrix W₁ 2102 contains the weights of the first layer of the GCN model. An activation function denoted by σ is applied to the matrix 2104 to obtain a matrix σ(A^{j}*L^{j}*W₁) 2106. For example, the activation function σ may be the sigmoid function or the ReLU function. In FIG. 21B, the matrix σ(A^{j}*L^{j}*W₁) 2106 is multiplied on the left by the adjacency matrix A^{j} and on the right by a second weight matrix W₂ to obtain a matrix 2110. The weight matrix W₂ 2108 contains the weights of the second layer of the GCN model. The activation function σ is applied to the matrix 2110 to obtain a matrix σ(A^{j}*σ(A^{j}*L^{j}*W₁)*W₂) 2112. In FIG. 21C, the matrix σ(A^{j}*σ(A^{j}*L^{j}*W₁)*W₂) 2112 is multiplied on the left by the adjacency matrix A^{j} and on the right by a third weight matrix W₃ 2114 to obtain a predicted output matrix Oₚ^{j} 2116. The weight matrix W₃ 2114 contains the weights of the third layer of the GCN model.

Returning to FIG. 20, the predicted output matrix Oₚ^{j} 2116 is output from block 2003. In block 2004, the loss function may be computed by

$$Loss ( {O}_{p}^{j} , {O}^{j} ) = {\sum }_{i = 1}^{{d}_{j}} {( {o}_{j , i} - {o}_{j , i}^{p} )}^{2} \qquad ( 11 )$$

In decision block 2005, when the loss function satisfies the condition Loss(Oₚ^{j},O^{j})<ε, where ε is a loss threshold, training of the set of weights {W₁, . . . , W_{D}} stops and control flows to block 2007. Otherwise, if the loss function satisfies the condition Loss(Oₚ^{j},O^{j})>ε in decision block 2005, control flows to block 2006. In block 2006, the weights are adjusted by applying gradient descents to the loss function in Equation (11) with respect to the weights in the set of weights. The operations represented by blocks 2003-2005 are repeated for another graph selected from the training set Ω. In block 2007, a GCN model is formed from the trained set of weights when Loss(Oₚ^{j},O^{j})<ε.

An example of GCN model formed in block 2007 for the three-layer GCN described above with reference to FIGS. 21A-21C is given by

F_{GCN}(A,L)=A*σ(A*σ(A*L*W₁)*W₂)*W₃ (12)

where

A is a d×d adjacency matrix of a graph G=(A, L);

L is a d×k nodel label matrix of the graph G; and

weight matrices W₁, W₂, and W₃ have been trained to minimize the loss function in Equation (11).

The number of trained weight matrices in the GCN model obtained in block 2007 is based on the depth of the GCN. For a two-layer GCN, the GCN model obtained in block 2007 is given by

F_{GCN}(A,L)=A*σ(A*L*W₁)*W₂ (13)

For a four-layer GCN, the GCN model obtained in block 2007 is given by

F_{GCN}(A,L)=A*σ(A*σ(A*L*W₁)*W₂)*W₃)*W₄ (14)

What-if Scenarios

A user, such as an administrator or application owner, would like to know in advance of making a change to a distributed computing environment how the change will impact performance of one or more distributed applications running in the environment. In other words, a user proposes a “What if scenario” that corresponds to a change in a distributed computing environment. The change corresponds to a change in a graph that represents the current state of the distributed computing environment. The NN model, such as the GNN model or the GCN model, may be used to generate predicted KPIs of the one or more distributed applications in response to the proposed “What-if scenario.” The predicted KPIs can be used to determine whether to proceed with the proposed change or reject the proposed change, thereby avoiding a change to the distributed computing environment that creates a negative impact on the performance of the one or more distributed applications.

There are two categories of What-if scenarios: (1) What-if scenarios that change more than one property of one or more nodes of a graph, and (2) What-if scenarios that change the configuration or structure of a graph. Category (1) What-if scenarios result in a new graph with the same structure as the current graph except for changes to node labels of the nodes. One example of a category (1) What-if scenarios is “add more memory to host XYZ.” Another example is “reduce memory assigned to ABC VM. On the other hand, category (2) What-if scenarios result in a next graph with a different structure and node labels from the current graph. One example of a category (2) What-if scenario is “migrate ABC VM from host XYZ to host LMN.” Another example is “place host XYZ in maintenance mode.” With a category (2) What-if scenario, a next stable graph is created with additional or reduced numbers of nodes and a change in relationships between nodes and may also include changes to properties of existing nodes.

Category (1) What-if Scenarios

Category (1) What-if scenarios change node labels of a current graph and leave the configuration of the current graph unchanged. Let A_{c} and L_{c} be an adjacency matrix and a node label matrix of a current graph G_{c} that represents the current state of a distributed computing environment. Let Aₚ and Lₚ be an adjacency matrix and a node label matrix of a proposed graph Gₚ that represents a category (1) change to the distributed computing environment. For a category (1) What-if scenario. Aₚ=A_{c} and Lₚ≠L_{c}. In other words, for a category (1) What-if scenario, the adjacency matrix is the same for the current graph and the new graph of the distributed computing environment with changes. An NN model that has been trained on the training set for the distributed computing environment is a deterministic model that can be used to determine a predicted output in response to a category (1) change to the distributed computing environment. In a deterministic model, mathematical and logical relationships between elements are determined in advance and are not subject to uncertainty. For example, predicted output of a category (1) What-if scenario may be determined using a trained NN model for the distributed computing environment:

F(Aₚ,Lₚ)=F(A_{c},Lₚ)=Oₚ (15)

where
P(·,·) represents an NN model (e.g., GNN mode or a GCN model); and
Oₚ is the predicted output from the nodes of the distributed computing environment.
   When the predicted output Oₚ comprises KPIs for selected nodes of the distributed application, the predicted output Oₚ can be used to determine whether to proceed with the proposed change or reject the proposed change, thereby avoiding a change to the distributed computing environment that creates a negative impact on the performance of the distributed application. In one implementation, F(·,·) is the F_{GCN}(·,·) in Equations (12)-(14). In another implementation, F(·,·) is the φ_{w}(G) in Equation (8b).

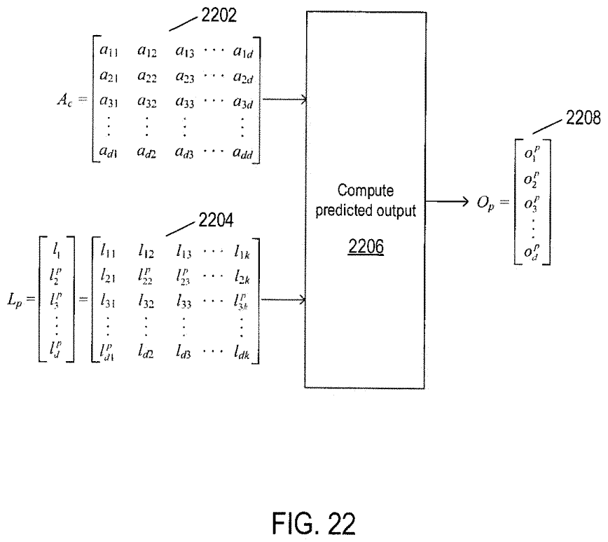

FIG. 22 shows a representation of computing a predicted output for a category (1) What-if scenario. Adjacency matrix 2202 is the adjacency matrix of the current graph. Node label matrix 2204 contains proposed changes to certain node labels identified by superscript p. For example, a proposed change to a node label denoted by l₂^{p} includes proposed change l₂₂^{p}, which may represent an increase in memory, and proposed change l₂₃^{p}, which may represent an increase in available disk space. Block 2206 represents computing a predicted output Oₚ 2208 using an NN model based on the adjacency matrix 2202 and the node label matrix 2204. The elements of the predicted output Oₚ 2208 may be compared with the elements of an output O of the current graph to determine whether to implement or reject the proposed change to the distributed computing environment. For example, the elements of the predicted output Oₚ 2208 may be predicted KPIs that are compared with KPIs of the current graph to determine whether to implement or reject the proposed change to the distributed computing environment.

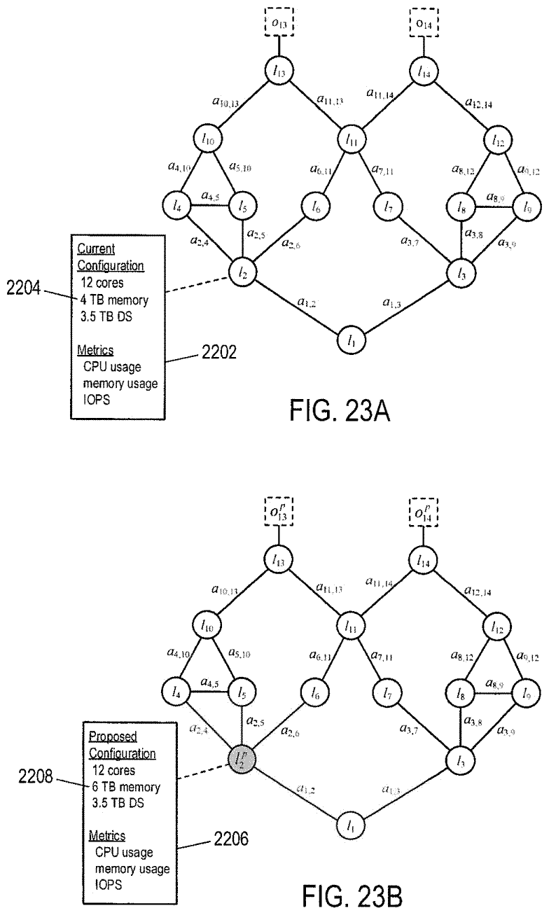

FIGS. 23A-23B show an example of a category (1) What-if scenario applied to a current graph to create a new graph with predicted KPIs. FIG. 23A is a reproduction of the graph shown in FIG. 17E and represents a current graph for the current state of the example distributed computing environment described above. FIG. 23A shows an example of a current node label l₂ 2202 of node n₂. Note that the current amount of memory for node n₂ is 4 TB memory 2204. FIG. 23B shows a new graph with the same adjacency matrix as the current graph shown in FIG. 23A. In FIG. 23B, proposed node label l₂^{p} 2206 shows a proposed change in which the memory for node n₂ is increased to 6 TB 2208. The current adjacency matrix and the node label matrix with proposed change in the node label l₂^{p} are input to a trained NN model, such as a GNN model or GCN model, of the distributed computing environment to obtain predicted outputs o₁₃^{p} and o₁₄^{p} (i.e., Inventory and Payroll KPIs). The predicted outputs o₁₃^{p} and o₁₄^{p} are compared with current KPIs o₁₃ and o₁₄ to determine whether the proposed change is benign, beneficial, and detrimental to the performance of the distributed application. For example, suppose the current KPIs o₁₃ and o₁₄ represent corresponding number of Inventory and Payroll requests processed per unit of time at a current time stamp. If the predicted KPIs satisfy the conditions o₁₃^{p}>o₁₃ and o₁₄^{p}>o₁₄, then the proposed change is beneficial, the proposed change may be executed to increase performance of the distributed application. On the other hand, if o₁₃^{p}<o₁₃ or o₁₄^{p}<o₁₄ or o₁₃^{p}≈o₁₃ and o₁₄^{p}≈o₁₄, the proposed change is rejected.

Category (2) What-if Scenarios

For category (2) What-if scenarios, there are many possible next graphs to consider. For example, when a VM is added to a cluster, there is no way to know in advance on which host to place and configure the VM to obtain a best possible result. Also, if N VMs are added to a cluster of M hosts, then there are approximately M^{N} possible next graphs. In another example, when a host is placed in maintenance mode, there are many ways that the VMs running on the host may be distributed to run on other hosts of the cluster. However, there does not exist a deterministic model that produces a unique next graph in response to a category (2) What-if scenario.

Computer-implemented methods described below receive as input a current graph representing a current state of a distributed computing environment and a proposed category (2) What-if scenario that corresponds to a proposed change to the distributed computing environment of the distributed application. The methods generate many different next graphs where, each next graph is a plausible representation of the proposed category (2) change to the distributed computing environment. In other words, each next graph represents a different way in which the distributed computing environment may be changed to incorporate the proposed category (2) What-if scenario. Predicted KPIs are generated for each next graph using the NN model obtained for the current graph and described above and predicted KPIs are aggregated to obtain aggregated predicted KPIs. The aggregated predicted KPIs are compared with KPIs of the current graph to determine whether proposed category (2) change is benign, beneficial, and detrimental to performance of the distributed computing environment. If the proposed change is beneficial the proposed change is executed on the distributed computing environment. Otherwise, the proposed change is rejected.

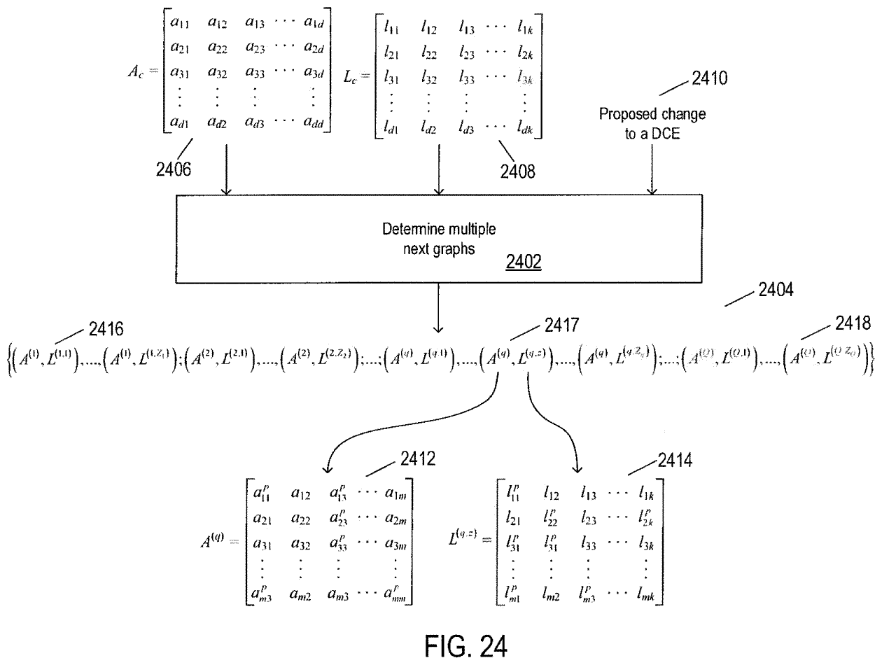

FIG. 24 shows an example of creating a set of next graphs from a current graph and a proposed change to a distributed computing environment. Block 2402 represents a process of determining a set of next graphs 2404 from receiving as input a current graph G_{c} comprising current adjacency matrix A, 2406 and a current node label matrix L_{c} 2408 and receiving as input a proposed change to the distributed computing environment 2410. Block 2402 is a distributed resource simulator that generates the set of next graphs 2404 subject to one or more of the following constraints: balancing workloads across hosts, minimization of power consumption, user-defined rules for placement of VMs on hosts, and rules regarding minimum resources needed to run the software components. Each of the many different next graphs corresponds to one of many different optimized arrangements of VMs and/or hosts of the distributed computing environment. For each configuration of nodes and edges there may be many different ways in which the resources of the cluster are optimally distributed to the VMs. For example, in a case where a proposed change to a distributed computing environment is an addition of a VM to, or deletion of a VM from, a cluster, the distributed resource simulator in block 2402 automatically generates a number of next graphs. Each next graph represents a different spread of VMs across hosts of the cluster subject to any one or more of the following constraints: load balancing, power consumption, and user-define rules. For each distribution of VMs across the cluster, there are a number of different ways the resource pool of the cluster may be partitioned to the VMs based on the constraints. Consider for example a resource pool of a cluster of hosts with 32 cores and 10 TB of memory to distribute to 5 VMs. The distributed resource scheduler constructs a next graph with 5 VMs assigned 2 TB of memory, 4 VMs assigned 6 cores each and one VM assigned 8 cores based on one or more of the constraints. The distributed resource scheduler constructs another next graph with 4 VMs assigned 1.5 TB of memory and 7 cores and one VM assigned 4 TB of memory and 6 cores. In other words, for each configuration of nodes and edges there are many different ways the resources of the clusters can be partitioned to the VMs and each next graph represents just one of the different ways of distributing the resources. In FIG. 24, Q denotes the number of different configurations of nodes and edges, where q=1, 2, . . . , Q. For each configuration of nodes and edges, there are Z_{q} different ways in which the resources of a cluster may be partitioned to the VMs. Next graphs in the set of next graphs 2404 are denoted by

NG_{q,z}=(A^{(q)},L^{(q,z)}) (16)

where
A^{(q)} is the adjacency matrix of the q-th configuration of nodes and edges; and
L^{(q,z)} is the z-th node label matrix for the q-th configuration of nodes and edges.
   A category (2) change may produce Q adjacency matrices A⁽¹⁾, . . . , A^{(Q)} resulting from adding or removing one or more VMs and/or adding or removing one or more hosts to a distributed computing environment. Each of the adjacency matrices A^{(q)} may have Z_{q} different node configurations represented by a node label matrix L^{(q,z)}, where z=1, 2, . . . , Z_{q}. In other words, Z_{q} next graphs have the same adjacency matrix A^{(q)} that corresponds to a change in the structure of a distributing computing environment and each of the Z_{q} next graphs corresponds to a different node label matrix L^{(q,z)}. FIG. 24 shows an example m×m adjacency matrix A^{(q)} 2412 and an example node label matrix L^{(q,z)} 2414. Superscript “p” of adjacency matrix elements and node labels represent a change with respect to the current graph resulting from the proposed category (2) What-if scenario. The index m may be larger or smaller than d, depending on the type of proposed category (2) change to the distributed computing environment. For example, index m may be larger than d if a category (2) What-if scenario adds a host to the cluster and index m may be smaller than d if a category (2) What-if scenario removes a host from the cluster. Next graphs 2416-2418 have difference adjacency matrices A⁽¹⁾, A^{(q)}, and A^{(Q)} represent different node and edge configurations and L^{(1,1)} L^{(q,z)}, and L^{(Q,Z}^{_{Q}}⁾ represent different corresponding node label matrices.

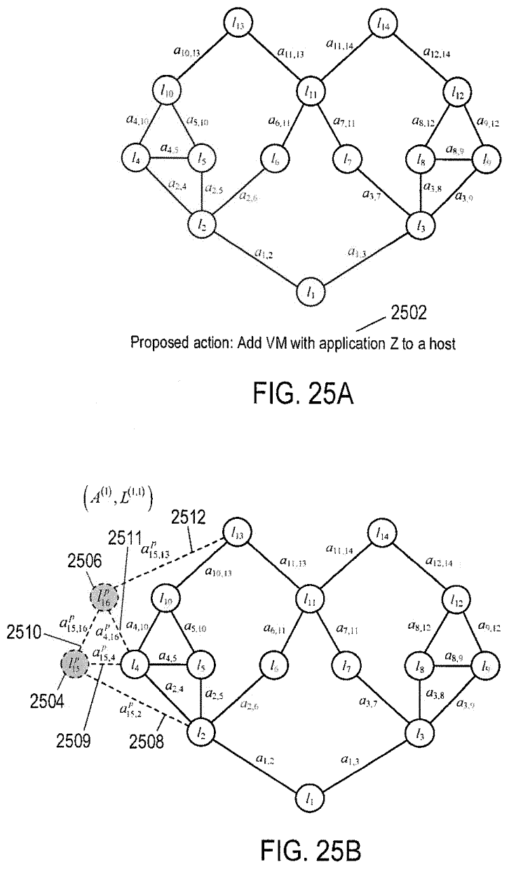

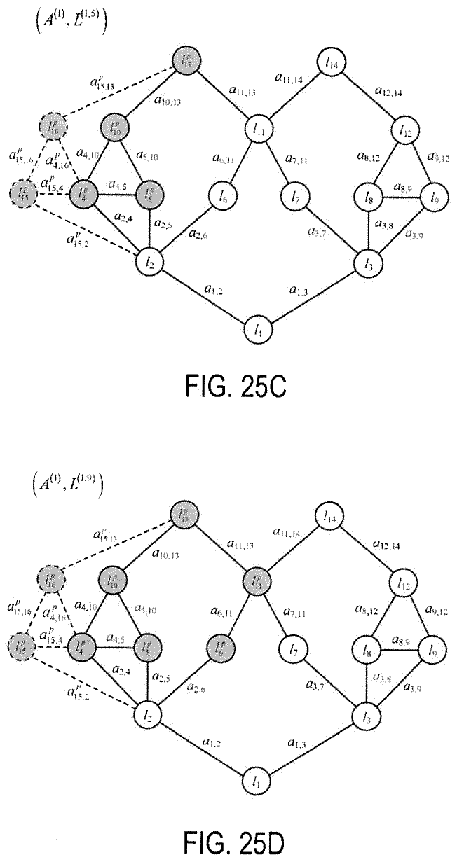

FIGS. 25A-25D show example next graphs that may be created in response to a category (2) What-if scenario in which a VM is added to the graph shown in FIG. 17E. In FIG. 25A, the graph shown in FIG. 17E is used an example current graph and includes a proposed category (2) change 2502. In FIG. 25B, an example next graph (A⁽¹⁾, L^{(1,1)}) is formed by adding a VM represented by new node 2504 with node label l₁₅^{p}. New node 2504 contains an application Z represented new node 2506 with node label l₁₆^{p}. Dashed edges 2508-2512 represent new dependencies with corresponding adjacency matrix elements a_{15,2}^{p}, a_{15,4}^{p}, a_{15,16}^{p}, a_{4,16}^{p}, and a_{15,13}^{p}, respectively. In this example, no changes are made to node labels of the nodes of the current graph. FIGS. 25C-25D have the same adjacency matrix A⁽¹⁾ as the next graph in FIG. 25B but configurations for certain nodes are different as represented by different node label matrices. In FIG. 25C, an example next graph (A⁽¹⁾, L^{(1,5)}) with node labels l₄^{p}, l₅^{p}, l₁₀^{p}, and l₁₃^{p} represent changes to the configurations of corresponding nodes n₄, n₅, n₁₀, and n₁₃. In FIG. 25D, an example next graph (A⁽¹⁾, L^{(1,9)}) with node labels l₄^{p}, l₅^{p}, l₆^{p}, l₁₀^{p}, l₁₁^{p}, and l₁₃^{p} represent changes to the configurations of corresponding nodes n₄, n₅, n₆, n₁₀, n₁₁, and n₁₃.

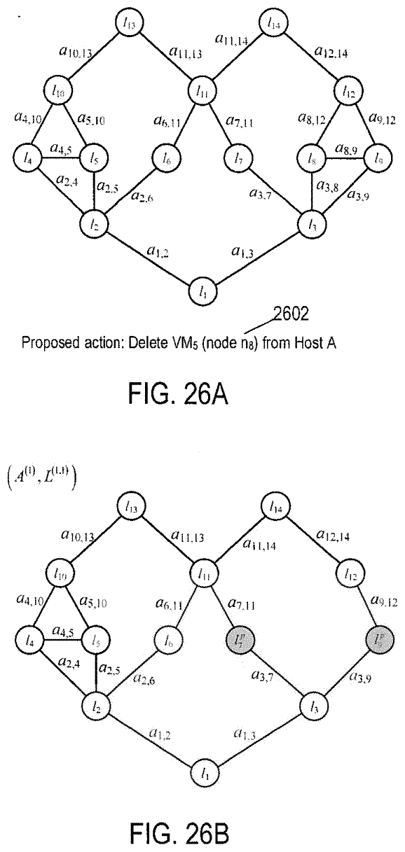

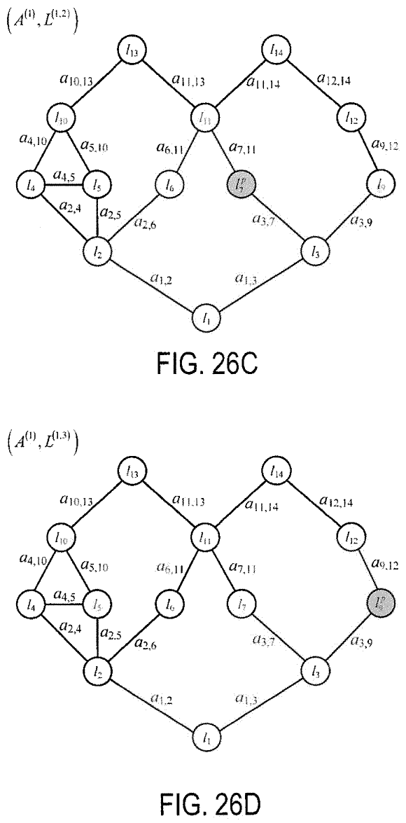

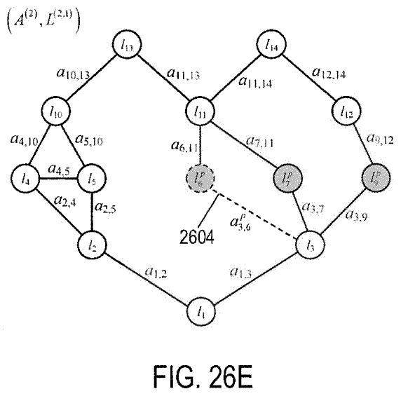

FIGS. 26A-26E show example next graphs that may be created in response to a category (2) What-if scenario in which a VM is removed from the graph shown in FIG. 17E. In FIG. 26A, the graph shown in FIG. 17E is used an example current graph and includes a proposed category (2) change 2602. In FIG. 26B-26D node n₈ and corresponding edges e_{3,8}, e_{8,9}, and e_{8,12} have been deleted with corresponding zero matrix elements in adjacency matrix A⁽¹⁾. In the example next graph (A⁽¹⁾,L^{(1,1)}) of FIG. 26B, resources of node n₃ have been redistributed such that the resources are shared by the VMs of nodes n₇ and n₉ as represented by node labels l₇^{p} and l₉^{p}. In the example next graph (A⁽¹⁾,L^{(1,2)}) of FIG. 26C, the VM in node n₇ has been assigned the resources previously used by node no as represented by node label l₇^{p}. In the example next graph (A⁽¹⁾,L^{(1,3)}) of FIG. 26D, the VM in node n₉ has been assigned the resources previously used by node n₈ as represented by node label l₉^{p}. In FIG. 26E, node n₆ has been migrated to node n₃, edge e_{2,6} has been deleted, and new edge e_{3,6} 1604 created with corresponding matrix elements changed in adjacency matrix A⁽²⁾. In this example, an example next graph (A⁽²⁾,L^{(2,1)}) with node labels l₆^{p}, l₇^{p}, and l₉^{p} represent changes to the configurations of corresponding nodes n₆, n₇, and n₉.

A predicted output is computed for each next graph as follows:

$$F ( {A}^{( q )} , {L}^{( q , z )} ) = {O}_{p}^{( q , z )} \\ \\ where \\ \\ {O}_{p}^{( q , z )} = [ \begin{matrix}{o}_{1}^{( q , z )} \\ {o}_{2}^{( q , z )} \\ ⋮ \\ {o}_{R}^{( q , z )}\end{matrix} ] \qquad ( 17 )$$

The predicated nodes outputs o₁^{(q,z)}, o₂^{(q,z)}, . . . , and o_{R}^{(q,z)} may be KPIs for R nodes of the next graph (A^{(q)},L^{(q,z)}).

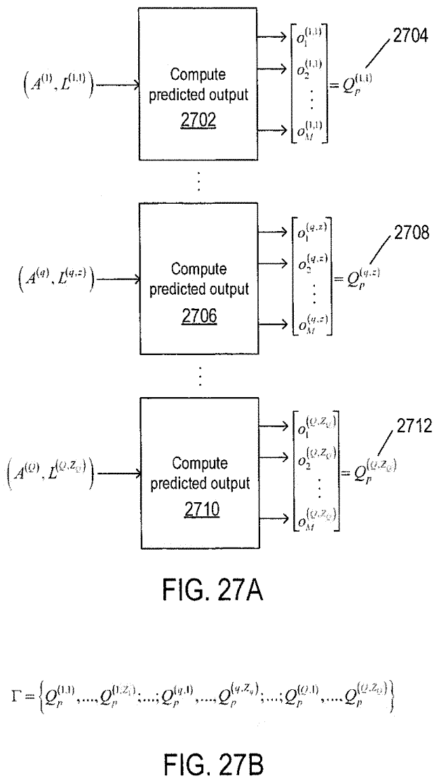

FIG. 27A shows an example of computing a predicted output for each of the next graphs in the set of next graphs 2404. For example, block 2702 represents computing a predicted output 2704 for next graph 2416. Block 2706 represents computing a predicted output 2708 for next graph 2717. Block 2710 represents computing a predicted output 2712 for next graph 2418. The outputs are collected to form a set of outputs denoted by Γ as shown in FIG. 27B. Each output in the set of outputs Γ corresponds to a next graph in the set of graphs 2404 in FIG. 24 and is obtained by applying the trained NN model in Equation (17).

The predicted node outputs of the next graphs form a set of outputs Γ. The predicted node outputs are aggregated to obtain aggregated predicted node outputs for the proposed category (2) change. In one implementation, for r=1, . . . , R, aggregated predicted KPIs are computed as an average of the predicted KPIs given by

$${o}_{r}^{A} = \frac{1}{\vert Γ \vert} {\sum }_{{NG}_{q , z} ∈ Γ} {o}_{r}^{( q , z )} \qquad ( 18 a )$$

where |Γ| is the cardinality of the subset Γ.

In an alternative implementation, for r=1, . . . R, aggregated predicted KPIs are the median of the predicted KPIs given by

oᵣ^{A}*=median{oᵣ^{{q,z)}}_{NG}_{_{q,z}}_{∈Γ} (18b)

The aggregated predicted KPIs form a set of aggregated predicted KPIs Oₚ^{A}={o₁^{A}, o₂^{A}, . . . , o_{R}^{A}} that are compared with the KPIs o₁, o₂, . . . . o_{R} of the current state of the distributed application. When the predicted KPIs indicate an improved performance is expected for the distributed application as a result of the proposed category (2) change, the category (2) change may be executed on the distributed computing environment. For example, suppose the current KPIs o₁₃ and o₁₄ represent corresponding number of Inventory and Payroll requests processed per unit time at a current time stamp. If aggregated predicted KPIs satisfy the conditions o₁₃^{A}>o₁₃ and o₁₄^{A}>o₁₄, then the proposed category (2) change is beneficial and the proposed category (2) change may be executed to increase performance of the Inventory and Payroll packages. On the other hand, if o₁₃^{A}<o₁₃ or o₁₄^{A}<o₁₄ or o₁₃^{A}≈o₁₃ and o₁₄^{A}≈o₁₄, the proposed category (2) change is rejected.

The methods described below with reference to FIGS. 28-32 are stored in one or more data-storage devices as machine-readable instructions and are executed by one or more processors of a computer system, such as the computer system shown in FIG. 1. A user initiates the computer-implemented method described in blocks 28-32 via a graphical user interface (“GUI”) of a system administrator console described above with reference to FIG. 13. For example, a user may submit via the GUI a proposed change to a graph of a distributed computing environment of a distributed application.

FIG. 28 is a flow diagram of a method for predicting behavior of a distributed application in response to a proposed change to a distributed computing environment. In block 2801, a “construct a training set of graphs of the distributed computing environment” procedure is performed. An example implementation of the “construct a training set of graphs of the distributed computing environment” procedure is described below with reference to FIG. 29. In block 2802, a “train a neural network (“NN”) model of the distributed computing environment” procedure is performed. An example implementation of the “train an NN model of the distributed computing environment” procedure is described below with reference to FIG. 30. In block 2803, a “predict behavior of the distributed application in response to a proposed change to the distributed computing environment” procedure is performed. An example implementation of the “predict behavior of the distributed application in response to a proposed change to the distributed computing environment” procedure is described below with reference to FIG. 31. In block 2804, a “determine whether proposed change is beneficial or detrimental to performance of the distributed application” procedure is performed. An example implementation of the “determine whether proposed change is beneficial or detrimental to performance of the distributed application” procedure is described below with reference to FIG. 32. In decision block 2805, when the proposed change is determined to be detrimental to performance of the distributed application, control flow to block 2806. Alternatively, when the proposed change is determined to be beneficial to performance of the distributed application, control flows to block 2807. In block 2806, the proposed change to the distributed computing environment is rejected. In block 2807, the proposed change to the distributed computing environment is executed. In other words, the distributed application and/or hardware of the distributed computing system used to execute the distributed application are changed in accordance with the proposed change.

FIG. 29 is a flow diagram illustrating an example implementation of the “construct a training set of graphs of the distributed computing environment” procedure performed in block 2801. A loop beginning with block 2901 repeats the computational operations represented by blocks 2902-2907 for each time stamp in a series of time stamps. In block 2902, an infrastructure inventory of object of the distributed computing environment is collected from a data-storage device at the current time stamp. In block 2903, configurations of the objects are determined as described above with reference to FIG. 15. In block 2904, relationships between the objects are determined as described above with reference to FIG. 15. In block 2905, an inventory of applications of the distributed application is determined as described above with reference to FIG. 15. In block 2906, KPIs of the distributed application are collected from the data-storage device. In block 2907, a graph is constructed from the infrastructure inventory, configurations of the objects, relationships between the objects, application inventory, and KPIs as described above with reference to FIGS. 16A-16C. In decision block 2908, the operations represented by blocks 2902-2907 are repeated for another time stamp. In block 2909, a training set 0 is formed from the graphs acquired in blocks 2901-2907 as described above with reference to FIG. 18 and Equation (6).

FIG. 30 is a flow diagram illustrating an example implementation of the “train a neural network (“NN”) model of the distributed computing environment” procedure performed in block 2802. A loop beginning with block 3001 repeats the computational operations represented by blocks 3002-3010 for each of the graphs in the training set fl. In block 3002, a matrix 2104 is computed. In block 3003, an activation function is applied to the matrix 2104 as described above with reference to FIG. 21A. In block 3004, a matrix 2110 is computed. In block 3005, an activation function is applied to the matrix 2110 as described above with reference to FIG. 21B. In block 3006, a predicted output is computed as described above with reference to FIG. 21C. Block 3007 represents the output associated with the graph selected from the training set in block 3001. In block 3008, a loss function is computed as described above with reference to Equation (11). In decision block 3009, when the loss function is less than a loss threshold, control flows to block 3010. Otherwise control flows to decision block 3011. In block 3010, the weights of the weight matrix W₁, W₂, and W₃ are optimized using gradient descents. In decision block 3011, the operations represented blocks 3002-3010 are repeated for another graph in the training set.

FIG. 31 is a flow diagram illustrating an example implementation of the “predict behavior of the distributed application in response to a proposed change to the distributed computing environment” procedure performed in block 2804. In decision block 3101, when the proposed change input by a user is category (1) What-if scenario, control flows to block 3102. Otherwise, the proposed change is a category (2) What-if scenario and control flows to block 3103. In block 3102, predicted KPIs are computed as described above with reference to Equation (15). In block 3103, a set of next graphs is determined as described above with reference to FIG. 24. In block 3104, predicted outputs are computed for each of the next graphs as described above with reference to Equation (17) and FIG. 27A. In block 3109, the predicted outputs obtained in block 3104 are aggregated to obtain predicted KPIs as described above with reference to Equations (18a) and (18b).

FIG. 32 is a flow diagram illustrating an example implementation of the “determine whether proposed change is beneficial or detrimental to performance of the distributed application” procedure performed in block 2805. In block 3201, predicted KPIs are compared to the KPIs of the current state of the distributed application. In decision block 3202, when the predicted KPIs indicate an improvement in the performance of the distributed application with respect to the current KPIs, control flows to block 3203. Otherwise, control flows to block 3204. In block 3203, an indication that the proposed change is beneficial to performance of the distributed application is displayed on a GUI of a system administrator's console. In block 3204, an indication that the proposed change is detrimental to performance of the distributed application is displayed on the GUI of a system administrator's console.

### Simulation Results

FIG. 33 shows a plot of predicted and actual KPIs for five applications denoted by wp1, wp2, wp3, wp4, and wp5. The results shown in FIG. 33 demonstrates the accuracy of the KPI prediction models in Equation (8b). A load-generator pushing a heavy computational load through the five applications. A KPI was defined for each application as a combination of correctness, throughput, and latency into a single quantity per application. Each application comprised 30 VMs, for a total of 130 VMs. The VMs were run in a vCenter cluster of five ESXi hosts. Occasionally hosts were removed and added to the cluster, which caused the KPIs to fluctuate as the applications competed for the pool of resources. FIG. 33 shows the predicted and actual KPI values as the system. The horizontal axis is the predicted KPI. The vertical axis is the actual KPI. Each data-point has a predicted KPI component and an actual KPI component. Perfect accuracy corresponds to points that lie on a line 3302 of slope one (i.e., predicted KPI equals actual KPI). The points generally fall near the line 3302, which indicates the prediction KPIs are reasonably accurate.

FIG. 34 shows a plot of sample results for predicting KPIs of the applications wp1, wp2, wp3, wp4, and wp5 after a change was made to the cluster of five ESXi hosts. In this example, results are shown for category (2) What-if scenario in which an ESXi host is removed from the cluster. The environment was the same as described for FIG. 33. The points generally fall near the line 3402, which indicates the prediction KPIs are reasonably accurate.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method stored in one or more data-storage devices and executed using one or more processors of a computer system for predicting behavior of a distributed application in response to a proposed change to a distributed computing environment in which the distributed application is executed, the method comprising:
constructing a training set of graphs of the distributed computing environment, each graph representing a state of the distributed computing environment at a time stamp;
training a neural network (“NM”) model of the distributed computing environment based on the set of graphs;
determining a predicted key performance indicator (“KPI”) for the distributed application based on the NN model in response to receiving the proposed change to the distributed computing environment via a user interface; and
executing the proposed change to the distributed computing environment when the predicted KPI indicates the proposed change is beneficial to performance of the distributed application.

2. The method of claim 1 wherein constructing the set of graphs of the distributed computing environment comprises:
for each time stamp
collecting infrastructure inventory of objects of the distributed computing environment from a data-storage device,
determining configurations of the objects,
determining relationships between the objects,
determining inventory of applications of the distributed application,
determining key performance indicators of the distributed application, and
constructing a graph that represents a state of the distributed computing environment at the time stamp based on the infrastructure inventory, configuration of objects, relationships between objects, inventory of applications, and key performance indicators; and
forming the training set of graphs from the graphs.

3. The method of claim 1 wherein training the NN model of the distributed computing environment comprising a graph neural network (“GNN”) model of the distributed computing environment based on the training set of graphs.

4. The method of claim 1 wherein training the NN model of the distributed computing environment comprising a graph convolutional network (“GCN”) model of the distributed computing environment based on the training set of graphs.

5. The method of claim 1 wherein determining the KPI for the distributed application based on the NN model in response to receiving the proposed change comprises:
determining whether the proposed change is a category (1) What-if scenario or a category (2) What-if scenario;
in response to the proposed change being a category (1) What-if scenario, computing a predicted key performance indicator of the distributed application based on a graph representing a current state of the distributed computing environment and the NN model;
in response to the proposed change being a category (2) What-if scenario,
determining a set of next graphs, each next graph representing a plausible state of the distributed computing environment resulting from the proposed change, and
computing a predicted output for each next graph; and
aggregating the predicted outputs to obtain a predicted KAI of the distributed application.

6. The method of claim 1 wherein executing the proposed change to the distributed computing environment when the KPI indicates the proposed change is beneficial to performance of the distributed application comprises:
comparing the predicted KPI with a current KPI that represents performance of the distributed computing environment in a current state; and
executing the proposed change to the distributed computing environment when the predicated KPI indicates an improvement in performance of the distributed application with respect to the current KPI.

7. A computer system for predicting behavior of a distributed application in response to a proposed change to a distributed computing environment in which the distributed application is executed, the system comprising:
one or more processors;
one or more data-storage devices; and
machine-readable instructions stored in the one or more data-storage devices that when executed using the one or more processors controls the system to perform operations comprising:
constructing a training set of graphs of the distributed computing environment, each graph representing a state of the distributed computing environment at a time stamp;
training a neural network (“NN”) model of the distributed computing environment based on the set of graphs;
determining a predicted key performance indicator (“KPI”) for the distributed application based on the NN model in response to receiving the proposed change to the distributed computing environment via a user interface; and
executing the proposed change to the distributed computing environment when the predicted KPI indicates the proposed change is beneficial to performance of the distributed application.

8. The system of claim 7 wherein constructing the set of graphs of the distributed computing environment comprises:
for each time stamp
collecting infrastructure inventory of objects of the distributed computing environment from a data-storage device,
determining configurations of the objects,
determining relationships between the objects,
determining inventory of applications of the distributed application,
determining key performance indicators of the distributed application, and
constructing a graph that represents a state of the distributed computing environment at the time stamp based on the infrastructure inventory, configuration of objects, relationships between objects, inventory of applications, and key performance indicators; and
forming the training set of graphs from the graphs.

9. The system of claim 7 wherein training the NN model of the distributed computing environment comprising a graph neural network (“GNN”) model of the distributed computing environment based on the training set of graphs.

10. The system of claim 7 wherein training the NN model of the distributed computing environment comprising a graph convolutional network (“GCN”) model of the distributed computing environment based on the training set of graphs.

11. The system of claim 7 wherein determining the KPI for the distributed application based on the NN model in response to receiving the proposed change comprises:
determining whether the proposed change is a category (1) What-if scenario or a category (2) What-if scenario;
in response to the proposed change being a category (1) What-if scenario, computing a predicted key performance indicator of the distributed application based on a graph representing a current state of the distributed computing environment and the NN model;
in response to the proposed change being a category (2) What-if scenario,
determining a set of next graphs, each next graph representing a plausible state of the distributed computing environment resulting from the proposed change, and
computing a predicted output for each next graph; and
aggregating the predicted outputs to obtain a predicted KPI of the distributed application.

12. The system of claim 7 wherein executing the proposed change to the distributed computing environment when the KPI indicates the proposed change is beneficial to performance of the distributed application comprises:
comparing the predicted KPI with a current KPI that represents performance of the distributed computing environment in a current state; and
executing the proposed change to the distributed computing environment when the predicated KPI indicates an improvement in performance of the distributed application with respect to the current KPI.

13. A non-transitory computer-readable medium encoded with machine-readable instructions that implement a method carried out by one or more processors of a computer system to perform operations comprising:
constructing a training set of graphs of a distributed computing environment of distributed application, each graph representing a state of the distributed computing environment at a time stamp;
training a neural network (“NN”) model of the distributed computing environment based on the set of graphs;
determining a predicted key performance indicator (“KPI”) for the distributed application based on the NN model in response to receiving a proposed change to the distributed computing environment via a user interface; and
executing the proposed change to the distributed computing environment when the predicted KPI indicates the proposed change is beneficial to performance of the distributed application.

14. The medium of claim 13 wherein constructing the set of graphs of the distributed computing environment comprises:
for each time stamp
collecting infrastructure inventory of objects of the distributed computing environment from a data-storage device,
determining configurations of the objects,
determining relationships between the objects,
determining inventory of applications of the distributed application,
determining key performance indicators of the distributed application, and
constructing a graph that represents a state of the distributed computing environment at the time stamp based on the infrastructure inventory, configuration of objects, relationships between objects, inventory of applications, and key performance indicators; and
forming the training set of graphs from the graphs.

15. The medium of claim 13 wherein training the NN model of the distributed computing environment comprising a graph neural network (“GNN”) model of the distributed computing environment based on the training set of graphs.

16. The medium of claim 13 wherein training the NN model of the distributed computing environment comprising a graph convolutional network (“GCN”) model of the distributed computing environment based on the training set of graphs.

17. The medium of claim 13 wherein determining the KPI for the distributed application based on the NN model in response to receiving the proposed change comprises:
determining whether the proposed change is a category (1) What-if scenario or a category (2) What-if scenario;
in response to the proposed change being a category (1) What-if scenario, computing a predicted key performance indicator of the distributed application based on a graph representing a current state of the distributed computing environment and the NN model;
in response to the proposed change being a category (2) What-if scenario,
determining a set of next graphs, each next graph representing a plausible state of the distributed computing environment resulting from the proposed change,
computing a predicted output for each next graph; and
aggregating the predicted outputs to obtain a predicted KAI of the distributed application.

18. The medium of claim 13 wherein executing the proposed change to the distributed computing environment when the KPI indicates the proposed change is beneficial to performance of the distributed application comprises:
comparing the predicted KPI with a current KPI that represents performance of the distributed computing environment in a current state; and
executing the proposed change to the distributed computing environment when the predicated KPI indicates an improvement in performance of the distributed application with respect to the current KPI.
